(19) United States
(12) Patent Application Publication
(10) Pub. No.: US 2024/0005597 A1
(43) Pub. Date: Jan. 4, 2024

(54) MODELLING AN ENVIRONMENT USING IMAGE DATA

(71) Applicant: Imperial College Innovations Limited, London (GB)

(72) Inventors: Edgar SUCAR, Oxford (GB); Shikun LIU, London (GB); Joseph ORTIZ, Menlo Park, CA (US); Andrew DAVISON, London (GB)

(21) Appl. No.: 18/469,392

(22) Filed: Sep. 18, 2023

Related U.S. Application Data
(63) Continuation of application No. PCT/GB2022/050673, filed on Mar. 16, 2022.

(30) Foreign Application Priority Data
Mar. 19, 2021 (GB) 2103885.6

(51) Int. Cl. G06T 17/00; G06T 7/11; G06T 7/50; G06T 7/70; G06V 10/75

(52) U.S. Cl. CPC G06T 17/00; G06T 7/11; G06T 7/50; G06T 7/70; G06V 10/751; G06T 2207/20084

(57) ABSTRACT

A method comprising obtaining image data captured by a camera device. The image data represents an observation of an environment. A two-dimensional representation of at least part of the environment is obtained using a model of the environment. The method includes evaluating a difference between the two-dimensional representation and at least part of the observation. The at least part of the observation is of the at least part of the environment represented by the two-dimensional representation. Based on the difference, a portion of the image data is selected for optimising the model. The portion of the image data represents a portion of the observation of the environment. The method comprises optimising the model using the portion of the image data.

### CROSS-REFERENCE TO RELATED APPLICATIONS

This application is a continuation under 35 U.S.C. § 120 of International Application No. PCT/GB2022/050673, filed Mar. 16, 2022, which claims priority to GB Application No. 2103885.6, filed Mar. 19, 2021, under 35 U.S.C. § 119(a). Each of the above-referenced patent applications is incorporated by reference in its entirety.

### BACKGROUND

### Technical Field

The present invention relates to methods and systems for obtaining a model of an environment, which may for example be used by a robotic device to navigate and/or interact with its environment.

### Background

In the field of computer vision and robotics, there is often a need to construct a model of an environment, such as a three-dimensional space that is navigable using a robotic device. Constructing a model allows a real-world environment to be mapped to a virtual or digital realm, where a representation of the environment may be used and manipulated by electronic devices. For example, a moveable robotic device may require a representation of a three-dimensional space, which may be generated using simultaneous localisation and mapping (often referred to as “SLAM”), to allow navigation of and/or interaction with its environment.

Operating SLAM systems in real-time remains challenging. For example, many existing systems need to operate off-line on large datasets (e.g. overnight or over a series of days). It is desired to provide 3D scene mapping in real-time for real-world applications.

Newcombe et al., in their paper “KinectFusion: Real-Time Dense Surface Mapping and Tracking”, published in the Proceedings of the International Symposium on Mixed and Augmented Reality (ISMAR), 2011, describe an approach for mapping scenes from Red, Green, Blue and Depth (RGB-D) data, where multiple frames of RGB-D data are registered and fused into a three-dimensional voxel grid. Frames of data are tracked using a dense six-degree-of-freedom alignment and then fused into the volume of the voxel grid. However, voxel-grid representations of an environment require large amounts of memory for each voxel. Furthermore, voxel-based representations can be inaccurate for regions of an environment that are not fully visible in the obtained RGB-D data, e.g. occluded or partly occluded regions. Similar issues arise when using point-cloud representations of an environment.

The paper “NeRF: Representing Scenes as Neural Radiance Fields for View Synthesis” by B. Mildenhall et al., presented at the European Conference on Computer Vision (ECCV), 2020, sets out a method for synthesizing views of complex scenes by processing a set of images with known camera poses using a fully-connected neural network. However, the method requires about 1-2 days to train off-line using a large number of training images and is therefore unsuitable for real-time use. Furthermore, the method presented in this paper assumes knowledge of the camera pose for a given image, which may not be available for example if images are captured as a robotic device is traversing its environment.

It is desirable to improve the modelling of an environment.

### SUMMARY

According to a first aspect of the present disclosure, there is provided a method, comprising: obtaining image data captured by a camera device, the image data representing an observation of an environment; obtaining a two-dimensional representation of at least part of the environment using a model of the environment; evaluating a difference between the two-dimensional representation and at least part of the observation, wherein the at least part of the observation is of the at least part of the environment represented by the two-dimensional representation; based on the difference, selecting a portion of the image data for optimising the model, wherein the portion of the image data represents a portion of the observation of the environment; and optimising the model using the portion of the image data.

In this way, a portion of the image data can be selectively obtained for optimising the model, for example rather than using all the image data obtained. This allows the optimisation to be performed more efficiently than otherwise, by reducing the amount of data to be processed and stored.

In some examples, the method comprises: using the model of the environment to generate a three-dimensional representation of the at least part of the environment; and obtaining the two-dimensional representation of the at least part of the environment using the three-dimensional representation. In this way, the two-dimensional representation used for the optimisation can be obtained from the model itself and optimised straightforwardly, by comparison with the observation.

In some examples, the observation comprises at least one image, and selecting the portion of the image data comprises selecting a subset of pixels of the at least one image. This further improves the efficiency of the optimisation process compared to using every pixel of an image.

In some examples, evaluating the difference comprises: evaluating the difference between a first portion of the observation and a corresponding portion of the two-dimensional representation, thereby generating a first difference; and evaluating the difference between a second portion of the observation and a corresponding portion of the two-dimensional representation, thereby generating a second difference less than the first difference, and selecting the portion of the image data comprises: selecting a first portion of the image data corresponding to the first portion of the observation, the first portion of the image data representing a first number of data points; and selecting a second portion of the image data corresponding to the second portion of the observation, the second portion of the image data representing a second number of data points, smaller than the first number of data points. With this approach, a larger number of data points are sampled for portions of an environment that deviate to a greater extent from the two-dimensional representation obtained by the model, so as to concentrate the optimisation procedure on regions that are not yet well-modelled by the model.

In some examples, the method comprises: evaluating a loss function based on the two-dimensional representation and the at least part of the observation of the environment, thereby generating a loss for optimising the model, wherein evaluating the loss function comprises evaluating the difference between the two-dimensional representation and the at least part of the observation; and selecting the portion of the image data based on the loss. The loss is for example indicative of how informative an observation is: observations of parts of the environment that contain a greater amount of information (such as highly detailed parts or parts which are not yet accurately represented by the model) tend to have a higher loss. Hence, selecting the portion of the image data based on the loss allows such observations (or parts of an observation) to be easily identified, so they can be used for the optimisation procedure.

In some examples, the observation comprises at least one image and selecting the portion of the image data comprises selecting a subset of pixels of the at least one image with a distribution of the subset of pixels across the at least one image based on a loss probability distribution generated by evaluating the loss function for the at least part of the observation. Selecting the set of pixels based on the loss probability distribution for example allows pixels to be sampled based on how useful they are likely to be in updating the model (e.g. how likely they are to correspond to parts of the environment with a large amount of detail and/or that are insufficiently represented by the model).

In some examples, at least one pixel of the subset of pixels is spatially disconnected from each other pixel in the subset of pixels. In this way, pixels can be sampled from across an image, e.g. so as to sample a variety of pixels corresponding to different spatial regions within the environment, which can improve the optimisation procedure compared to sampling solely a connected block of pixels for a particular spatial region of the environment.

In some examples, generating the loss probability distribution comprises: dividing the at least part of the observation into a plurality of regions; evaluating the loss function for each of the plurality of regions, thereby generating a region loss for the each of the plurality of regions; and generating the loss probability distribution based on the loss and the region loss of the each of the plurality of regions. This approach allows the loss probability distribution to be generated straightforwardly, based on the region loss which is for example indicative of to what extent the corresponding region of the environment is accurately represented by the model.

In some examples, the observation comprises a first frame and a second frame; evaluating the loss function comprises: evaluating the loss function based on the first frame and a two-dimensional representation of the first frame, thereby generating a first loss; evaluating the loss function based on the second frame and a two-dimensional representation of the second frame, thereby generating a second loss; and selecting the portion of the image data based on the loss comprises, in response to determining that the first loss is greater than the second loss: selecting a first number of pixels from the first frame; and selecting a second number of pixels from the second frame, and wherein the first number of pixels is greater than the second number of pixels. In other words, the number of pixels selected may differ between frames, for example to sample a larger number of pixels from frames corresponding to regions of the environment that are not yet well-modelled by the model, which can improve the optimisation process.

In some examples, the method comprises: determining a total loss for a group of frames for optimising the model, the group of frames comprising the first frame and the second frame, the determining the total loss comprising evaluating the loss function based on the group of frames and a corresponding set of two-dimensional representations of the group of frames; and determining the first number of pixels based on a contribution of the first loss to the total loss. This allows the number of pixels to be selected based on the relative contribution of the loss for those pixels to the total loss, for example to select a greater number of pixels if the contribution is larger. In this way, pixels can be more appropriately selected for the optimisation, which can improve the efficiency of the optimisation.

In some examples, the observation comprises a plurality of frames, the evaluating the difference comprises evaluating the difference between a respective frame of the plurality of frames and a two-dimensional representation of the respective frame, and selecting the portion of the image data comprises selecting, based on the difference, a subset of the plurality of frames to be added to a set of frames for optimising the model. This improves the efficiency of the optimisation compared to using all frames, irrespective of how well they are represented by the model.

In some examples, the plurality of frames comprises a frame, and the method comprises: obtaining a first set of pixels of the frame; generating a second set of pixels of the two-dimensional representation of the frame, wherein evaluating the difference comprises evaluating the difference between each pixel in the first set of pixels and a corresponding pixel in the second set of pixels; and determining a proportion of the first set of pixels for which the difference is lower than a first threshold, wherein the subset of the plurality of frames comprises the frame, and selecting the frame comprises selecting the frame in response to determining that the proportion is lower than a second threshold. In this way, it can be determined whether the frame is already well represented by the model. If so, the proportion will be higher than the second threshold and the frame need not be used in further optimising the model. This approach thus allows frames that are not yet well represented by the model to be identified and used to further optimise the model.

In some examples, the method comprises selecting a most recent frame captured by the camera device to be added to the set of frames. Using the most recent frame allows the model and camera pose estimate to be repeatedly updated as new frames are captured, to take into account new observations.

In some examples, the observation of the environment comprises a measured depth observation of the environment captured by the camera device; the two-dimensional representation comprises a rendered depth representation of the at least part of the environment; and the difference represents a geometric error based on the measured depth observation and the rendered depth representation. Use of the geometric error allows regions of the environment that are not yet accurately represented by the model to be straightforwardly identified, as such regions tend to be associated with a relatively high geometric error.

In some examples, the model of the environment comprises a neural network and obtaining the two-dimensional representation comprises applying a rendering process to an output of the neural network; and optimising the model comprises optimising a set of parameters of the neural network, thereby generating an update to the set of parameters of the neural network. A neural network can be used to predict representations for parts of an environment that have not yet been directly observed. A rendering process applied to the output of the neural network for example allows a two-dimensional representation that can be compared with the observation to be obtained straightforwardly from an implicit representation of the environment (the neural network). With this approach, the neural network parameters can be iteratively updated in a straightforward manner, without having to pre-train the neural network. For example, the neural network can instead be updated adaptively as more image data is obtained.

In some of these examples, the method comprises: obtaining a camera pose estimate for the observation of the environment, wherein the two-dimensional representation is generated based on the camera pose estimate; and jointly optimising the camera pose estimate and the set of parameters of the neural network based on the difference; thereby generating: an update to the camera pose estimate for the observation of the environment; and the update to the set of parameters of the neural network. This allows the model and camera pose estimate to be optimised to provide adaptive improvements to both the model and the camera pose estimate in an efficient manner, for example in real-time.

According to a second aspect of the present disclosure, there is provided a system, comprising: an image data interface to receive image data captured by a camera device, the image data representing an observation of an environment; an image data portion selection engine configured to: obtain a two-dimensional representation of at least part of the environment using a model of the environment; evaluate a difference between the two-dimensional representation and at least part of the observation, wherein the at least part of the observation is of the at least part of the environment represented by the two-dimensional representation; and based on the difference, select a portion of the image data for optimising the model, wherein the portion of the image data represents a portion of the observation of the environment; and an optimiser configured to optimise the model using the portion of the image data.

In some examples, the image data portion selection engine is configured to: use the model of the environment to generate a three-dimensional representation of the at least part of the environment; and obtain the two-dimensional representation of the at least part of the environment using the three-dimensional representation.

In some examples, the image data portion selection engine is configured to: evaluate a loss function based on the two-dimensional representation and the at least part of the observation of the environment, thereby generating a loss for optimising the model, wherein evaluating the loss function comprises evaluating the difference between the two-dimensional representation and the at least part of the observation of the environment; and select the portion of the image data based on the loss.

In some examples: the model of the environment comprises a neural network; the image data portion selection engine is configured to obtain the two-dimensional representation by applying a rendering process to an output of the neural network; and the optimiser is configured to optimise the model by optimising a set of parameters of the neural network, thereby generating an update to the set of parameters of the neural network.

In some examples, the image data portion selection engine is configured to: obtain a camera pose estimate for the observation of the environment; and generate the two-dimensional representation based on the camera pose estimate; and the optimiser is configured to jointly optimise the camera pose estimate and the set of parameters of the neural network based on the difference, thereby generating: an update to the camera pose estimate for the observation of the environment; and the update to the set of parameters of the neural network.

According to a third aspect of the present disclosure, there is provided a robotic device, comprising: a camera device configured to obtain image data representing an observation of an environment; the system provided by the fifth aspect of the present disclosure; and one or more actuators to enable the robotic device to navigate around the environment.

In some examples, the system is configured to control the one or more actuators to control navigation of the robotic device around the environment based on the model. In this way, the robotic device can move around the environment in accordance with the model, so as to perform precise tasks and movement patterns within the environment.

According to a fourth aspect of the present disclosure, there is provided a non-transitory computer-readable storage medium comprising computer-executable instructions which, when executed by a processor, cause a computing device to perform any of the methods described herein (alone or in combination with each other).

Further features will become apparent from the following description, which is made with reference to the accompanying drawings.

### BRIEF DESCRIPTION OF THE DRAWINGS

FIG. 1 is a schematic diagram showing a method for jointly optimising at least a camera pose estimate associated with an observation of at least part of an environment and a model of the environment according to examples;

FIG. 2 is a schematic diagram showing a method for generating rendered image data according to examples;

FIG. 3 is a schematic diagram showing a method for tracking a camera pose according to examples;

FIG. 4 is a schematic diagram showing a method for selecting a portion of image data for optimising a model of the environment according to examples;

FIGS. 5A and 5B is a schematic diagram showing a method for selecting a portion of image data for optimising a model of the environment according to further examples;

FIG. 6 is a schematic diagram showing a method for selecting a portion of image data for optimising a model of the environment according to further examples;

FIG. 7 is a schematic diagram showing a method for selecting a portion of image data for optimising a model of the environment according to further examples;

FIG. 8 is a schematic diagram showing a method for selecting a portion of image data for optimising a model of the environment according to further examples;

FIG. 9 is a schematic diagram showing a pipeline for a Simultaneous Localisation and Mapping (SLAM) system according to examples;

FIG. 10 is a schematic diagram showing a system for use with the method herein according to examples; and

FIG. 11 is a schematic diagram showing a robotic device according to examples.

### DETAILED DESCRIPTION

In examples described herein, image data is captured by a camera device. The image data represents an observation of an environment which, for example, is a three-dimensional (3D) space. A camera pose estimate associated with the observation is obtained. The camera pose estimate for example represents a pose (e.g. a position and an orientation) of the camera device at the point the observation is made. Rendered image data is generated based on the camera pose estimate and a model of the environment. The model is for generating a 3D representation of the environment. For example, the model may be a neural network configured to map a spatial coordinate corresponding to a location in the environment to a photometric value and a volume density value associated with the location, the volume density value being used to derive a depth value at the location. The rendered image data represents a rendered image portion corresponding to a portion of the environment observed. A loss function is evaluated based on the image data and the rendered image data to generate a loss. Based on the loss, at least the camera pose estimate and the model are jointly optimised to generate an update to the camera pose estimate and an update to the model. This approach for example allows for a learning of the environment so as to iteratively improve the camera pose estimate and the model of the environment. Optimising the model in this manner for example improves the accuracy of the 3D representation of the environment generated using the model. This joint optimisation may be applied in a SLAM system in which, in parallel to the joint optimisation, a tracking system continuously optimises a camera pose estimate for a latest frame captured by the camera device with respect to the updated model.

In some examples described herein, a portion of image data, representing a portion of an observation of an environment, is selected for optimising a model of the environment, such as the model discussed above. In these examples, the portion of the image data is selected based on a difference between a two-dimensional (2D) representation of at least part of the environment (e.g. an image portion as discussed above) and the observation, which is of the same at least part of the environment. By selecting a portion of the image data for optimising the model, the processing power and memory capacity required to optimise the model for each observation of the environment is reduced compared to other approaches, such as those that utilise an entire image for optimisation.

It is to be appreciated that, in examples described herein, methods for selecting a portion of the image data may be combined with methods for jointly optimising the camera pose estimate and the model such that the joint optimisation is performed using a portion of the image data, e.g. rather than all the image data. For example, the joint optimisation may be performed using a selected set of frames and/or a select number of pixels captured by the camera device. These selections may be guided by the differences evaluated between the image data and the rendered image data, where such differences may form part of an evaluated loss function used to perform the joint optimisation. This approach for example reduces the processing power and memory requirements of the joint optimisation process. Applied to a SLAM system, this approach allows for a SLAM system with a model for generating a dense 3D representation of the environment in which optimisation of the model (and hence of the 3D representation obtainable using the model) can be performed in real-time.

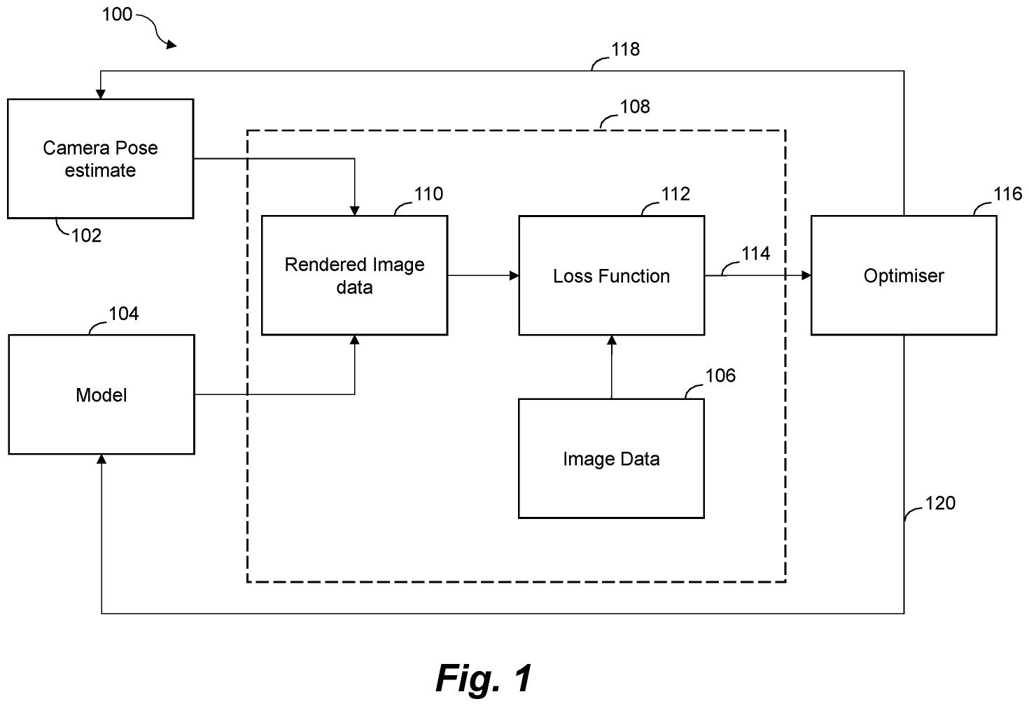

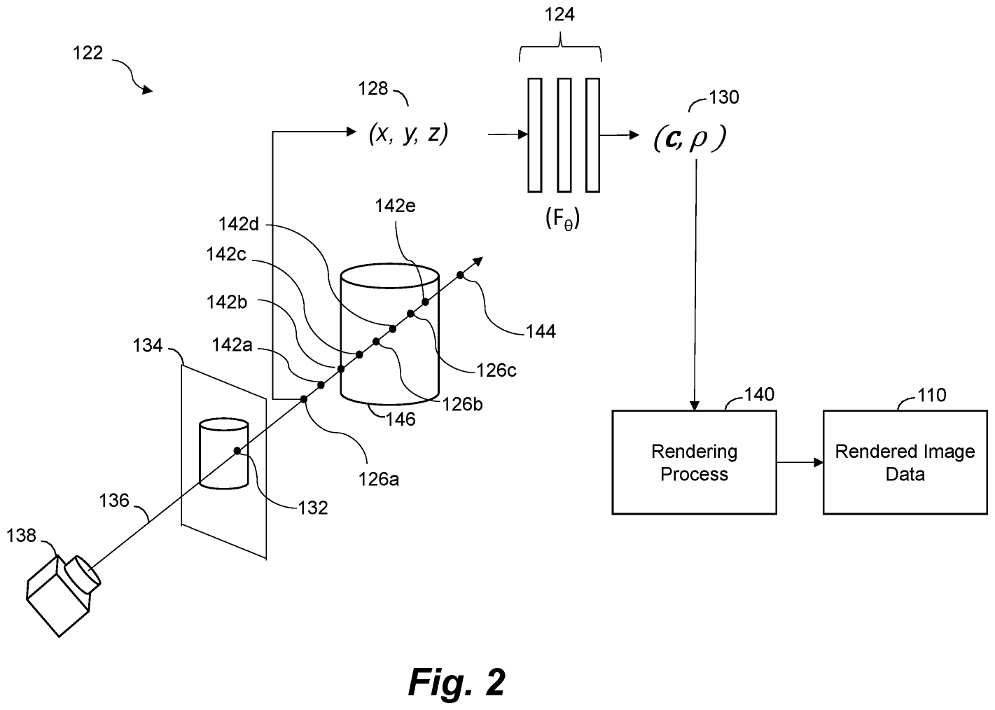

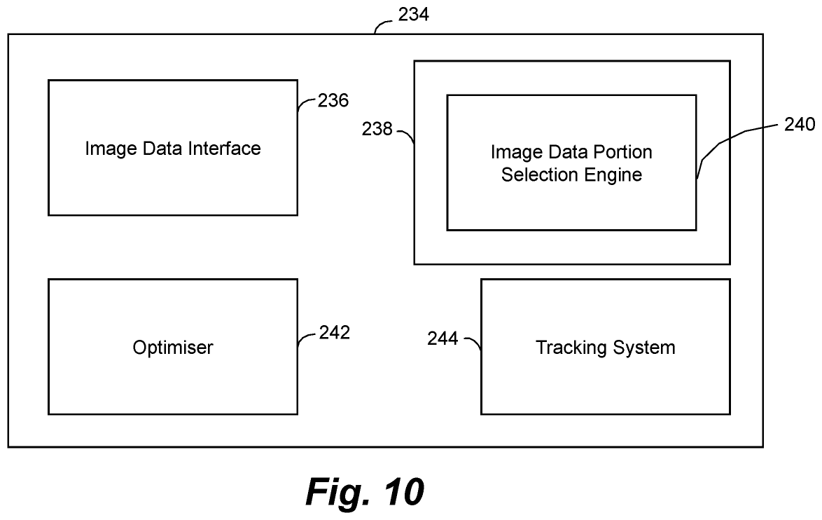

FIG. 1 is a schematic diagram showing a method 100 for jointly optimising at least a camera pose estimate 102 associated with an observation of at least part of an environment and a model 104 of the environment. An example of a system applying the method 100 is described in more detail below with reference to FIG. 10. In examples described herein, the environment is for example a 3D space, which may be an internal and/or an external physical space, e.g. at least a portion of a room or a geographical location. The environment may include a lower surface, e.g. a floor, or may be an aerial or extra-terrestrial environment. The model 104 of the environment is for generating a three-dimensional representation of the at least part of the environment corresponding to the observation, as will be described in more detail with reference to FIG. 2.

In the method 100 of FIG. 1, image data 106 representing an observation of at least part of an environment is obtained. The image data 106 is captured by a camera device. The camera device may be arranged to record data that results from observing the environment, either in digital or analogue form. The image data 106 may include photometric data (e.g. colour data). In some examples, the photometric data may comprise Red, Green and Blue (RGB) pixel values for a give resolution. In other examples, other colour spaces may be used and or the photometric data may comprise mono or grayscale pixel values. The image data 106 may include depth data indicating a distance from the camera device, e.g. each pixel or image element may represent a distance of a portion of the environment from the camera device. The camera device may comprise a so-called RGB-D camera arranged to capture image data including both photometric data in the form of RGB data and depth (“D”) data. In some cases, the image data 106 includes image data captured over time, e.g. a plurality of frames. In such cases, the image data may be considered to be video data and the camera device may be considered to be a video camera.

In the method 100 of FIG. 1, a rendering engine 108 is configured to obtain a camera pose estimate 102 associated with the observation. In examples described herein, the camera pose estimate 102 refers to an orientation and location of the camera device at the time the image data 106 representing the observation was captured. An orientation and location of the camera device may be defined in three dimensions with reference to six degrees of freedom (6DOF): i.e. a location being defined within each of the three spatial dimensions, e.g. by an [x, y, z] coordinate, and an orientation being defined by an angle vector representing a rotation about each of the three axes, e.g. [θₓ, θ_{y}, θ_{z}]. Location and orientation may be seen as a transformation within three dimensions, e.g. with respect to an origin defined within a 3D coordinate system for the environment. The 3D coordinate system may be referred to as the “world” coordinate system such that the camera pose estimate 102 (sometimes represented as T_{WC}) represents the location and orientation of the camera device as a transformation with respect to the origin of the world coordinate system. For example, the [x, y, z] coordinate may represent a translation from the origin to a particular location within the 3D coordinate system and the angle vector [θₓ, θ_{y}, θ_{z}] may define a rotation within the 3D coordinate system. A transformation having 6DOF may be defined as a matrix, such that multiplication by the matrix applies the transformation. The pose of a camera device may vary over time, e.g. as video data or a series of still images is recorded, such that a camera pose estimate at a time t+1 may be different than that at a time t. In a case of a robotic device comprising a camera device, the pose may vary as the robotic device moves about within the environment.

In the method 100 of FIG. 1, the rendering engine 108 generates rendered image data 110 based on the camera pose estimate 102 and the model 104. The rendered image data 110 is representative of at least one rendered image portion corresponding to the at least part of the environment. For example, the rendered image data 110 may represent a rendered image of a portion of the environment or at least one portion of such a rendered image (e.g. one or more pixels of the rendered image, which may be contiguous or non-contiguous).

The model 104 is for generating a 3D representation of the at least part of the environment. In some examples, the model 104 is configured to map a spatial coordinate corresponding to a location within the environment to a photometric value and a volume density value, both associated with the location within the environment. The volume density value is for deriving a depth value associated with the location within the environment. In this way, the photometric value and the volume density value provide a 3D representation of the at least part of the environment.

In some cases, the model 104 may be useable to obtain a dense 3D representation of at least part of the environment. For example, the model 104 may be used to obtain photometric values and volume density values for a large number of locations within the environment, e.g. hundreds of thousands or millions of locations, so as to provide an effectively continuous 3D representation of the environment, which may be considered to be a dense 3D representation. This may be compared to a sparse representation of an environment, which may for example be represented by ten to a hundred points. Although sparse representations generally have lower processing power and memory requirements, and thus may lend themselves more easily to a real-time SLAM system, dense representations are typically more robust in the sense that they provide a more complete representation of an environment. Use of a dense representation can also improve tracking and relocalisation of the camera pose estimate 102 due to more complete representation of the environment provided by the dense representation. In examples herein, processing power and memory requirements can be reduced by selecting a portion of the image data 106 for optimising the model of the environment, e.g. rather than using an entire image. This facilitates the use of a model 104 capable of generating a dense 3D representation within a real-time SLAM system.

In examples, the model 104 can map a given spatial coordinate within the environment to a photometric value and a volume density value. This therefore allows 3D representations of various resolutions to be obtained using the model 104, contrary to voxel and point-cloud representations of an environment, which have a fixed resolution. Use of a model such as this for example also enables the model 104 to be predictive of photometric and volume density values in locations within the environment which are not necessarily directly observed by the camera device, such as locations which are occluded or partly occluded. The model 104 in these cases may therefore be considered to itself provide an implicit, continuous 3D model of the environment as opposed to voxel- and point cloud-based representations which provide a 3D representation for discrete points in the environment.

Referring to FIG. 1, in some examples, generating the rendered image data 110 includes generating a 3D representation of at least part of the environment using the model 104. For example, a 3D representation may be obtained for a particular location within the environment (e.g. corresponding to a particular point in 3D space). A rendering process may then be performed using the 3D representation to generate at least one rendered image portion which provides a two-dimensional (2D) representation of the at least part of the environment. The rendering process in examples such as this is differentiable with respect to both the camera pose estimate 102 and a set of parameters of the model 104. This thus allows for joint optimisation of the camera pose estimate 102 and the model 104 using a gradient-based optimisation algorithm. An example of how the rendered image data 110 is generated and a rendering process itself is provided in detail below with reference to FIG. 2.

In the method 100 of FIG. 1, a rendering engine 108 evaluates a loss function 112 based on the image data 106 and the rendered image data 110, thereby generating a loss 114. The loss 114 is used for jointly optimising at least the camera pose estimate 102 and the model 104, as discussed below. The loss function 112 may be based on a comparison (e.g. a difference) between the image data 106 and the rendered image data 110. The loss 114 generated may therefore provide a measure of an accuracy of the rendered image data 110 in relation to the image data 106 captured by the camera device, which for example corresponds to a measured observation of the at least part of the environment. In examples, the camera pose estimate 102 and the model 104 are jointly optimised so as to reduce a value of the loss 114, so as to reduce the difference between a measured 2D representation (represented by the image data 106) and a predicted 2D representation (represented by the rendered image data 110).

In some examples, the image data 106 captured by the camera device includes photometric data (e.g. colour data) which includes at least one measured photometric image portion. In other words, the at least one measured photometric image portion may represent photometric properties of at least one image portion. In this example, the at least one rendered image portion may also comprise a corresponding at least one rendered photometric image portion, which similarly represents photometric properties of the at least one rendered image portion (which corresponds to the same at least one part of the environment as the at least one image portion). The loss function 112 in this case includes a photometric error, Lₚ, based on the least one measured photometric image portion and the at least one rendered photometric image portion. The photometric error in this case may for example be a difference between the at least one measured photometric image portion and the at least one rendered photometric image portion. In this example, joint optimisation of at least the camera pose estimate 102 and the model 104 can for example involve reducing a photometric error between the image data 106 and the rendered image data 110, so as to reduce photometric differences between the measured and predicted 2D representations.

In other examples, the image data 106 captured by the camera device additionally or alternatively includes depth data which includes at least one measured depth image portion. In other words, the at least one measured depth image portion may represent a depth value corresponding to the at least one image portion. In this example, the at least one rendered image portion may also include a corresponding at least one rendered depth image portion, which similarly represents a depth value of the at least one rendered image portion. The loss function 112 in this case includes a geometric error, L_{g}, based on the least one measured geometric image portion and the at least one rendered geometric image portion. The geometric error in this case may for example be a difference between the at least one measured geometric image portion and the at least one rendered geometric image portion. In this example, joint optimisation of at least the camera pose estimate 102 and the model 104 can for example involve reducing a geometric error between the image data 106 and the rendered image data 110, so as to reduce a difference in depth values between the measured and predicted 2D representations.

In an example where a geometric error, L_{g}, is used as a term in the loss function 112, the geometric error may be modified to account for uncertainties associated with a rendered depth image portion. In this way, the loss function 112 can be adapted e.g. so that rendered depth image portions with greater uncertainties contribute less to the geometric error used in the loss function 112, thereby improving the certainty in the geometric error used to jointly optimise the camera pose estimate 102 and the model 104. An example of a rendered depth image portion with large uncertainties is a rendered depth image portion corresponding to an object border in the environment. A rendered depth image portion corresponding to an object border typically has a larger associated uncertainty than a rendered depth image portion corresponding to a uniform surface in the environment, as an object border tends to correspond to an abrupt and relatively large change in depth. In some of these examples, the depth data includes a plurality of measured depth image portions and the at least one rendered image portion includes a plurality of rendered depth image portions each corresponding to a respective one of the plurality of measured depth image portions. In this case, the geometric error includes a plurality of geometric error terms, each term corresponding to a different one of the plurality of measured depth image portions. In these examples, the method 100 of FIG. 1 includes reducing a contribution to the geometric error of a first geometric error term associated with a first one of the plurality of measured depth image portions relative to a second geometric error term associated with a second one of the plurality of measured depth image portion. The reduction in the contribution may be based on a first measure of uncertainty associated with the first one of the plurality of measured depth image portions. Additionally or alternatively, the reduction in the contribution may be based on a second measure of uncertainty associated with the second one of the plurality of measured depth image portions. For example, the first measure of uncertainty may be larger than the second measure of uncertainty (e.g. if the first geometric error term is for a region of the environment corresponding to an object border and the second geometric error term is for a region of the environment corresponding to a uniform surface). In such cases, the contribution of the first geometric error term may be reduced for example if the first measure of uncertainty satisfies a particular condition (e.g. if a magnitude of the first measure of uncertainty exceeds a threshold value, or if the magnitude of the first measure of uncertainty is greater than the second measure of uncertainty by a certain proportion).

In the method 100 of FIG. 1, an optimiser 116 jointly optimises at least the camera pose estimate 102 and the model 104 based on the loss 114. This generates an update to the camera pose estimate 118 and an update 120 to the model. The update 120 to the model may be an update to a set of parameters of the model 104 used. The joint optimisation may involve iteratively evaluating the loss 114 for different camera pose estimates 102 and different values for the set of parameters of the model 104, so as to obtain a camera pose estimate 102 and a set of parameters of the model 104 for which a particular value of the loss 114 is obtained (e.g. a minimum value, or a value which satisfies a particular condition, such as being less than or equal to a threshold value). In this way, joint optimisation as described herein may be considered to involve optimisation of both the camera pose estimate 102 and the model 104 within the same optimisation process, e.g. within a single optimisation process. This may be viewed in contrast to separately optimising the camera pose estimate 102 and the model 104, e.g. by iteratively evaluating one loss for different camera pose estimates 102 until a particular value of that loss is obtained, corresponding to an optimised camera pose estimate, and separately iteratively evaluating another loss for different values for the set of parameters of the model 104 until a particular value of the other loss is obtained, corresponding to an optimised set of parameters of the model 104. Joint optimisation in examples herein therefore provides a more efficient mechanism for generating the update to the camera pose estimate 118 and the update 120 to the model.

For example, in a case where both the photometric error, Lₚ, and the geometric error, L_{g}, contribute to the loss function 112, the joint optimisation to be carried out may be expressed as follows:

$${min}_{θ , T} ( {L}_{g} + {λ}_{p} {L}_{p} ) ,$$

where θ represents a set of parameters of the model 104, T is the camera pose estimate 102 and λₚ is a factor for adjusting the contribution of the photometric error to the loss function 112 relative to the geometric error, where the factor λₚ may for example be predetermined (e.g. by empirically identifying a suitable value for the factor that appropriately balances the contribution of the photometric and geometric error terms). The joint optimisation may be performed by applying a gradient-based optimisation algorithm, such as an Adam optimiser algorithm described in the paper “Adam: A Method for Stochastic Optimization” by Kingma et al., presented at the International Conference on Learning Representations, 2015, the contents of which are incorporated herein by reference.

A gradient-based optimisation algorithm such as the Adam optimiser algorithm utilises gradients of the loss function 112 with respect to any variables to be optimised, which in this case is the camera pose estimate 102 and the set of parameters of the model 104. In the present case, this involves evaluating gradients for the rendered image portion(s) represented by the rendered image data 110 with respect to the camera pose estimate 102 and the set of parameters of the model 104 (the image portion(s) represented by the image data 106 represent measured observations and hence do not depend on the camera pose estimate 102 and the set of parameters of the model 104). These gradients may be obtained during a differentiable rendering process for obtaining the rendered image data 110 In such examples, the method 100 includes the rendering engine 108 evaluating a first gradient of the at least one rendered image portion with respect to the camera pose estimate 102, thereby generating a first gradient value. The rendering engine 108 also evaluates a second gradient of the at least one rendered image portion with respect to the set of parameters of the model 104, thereby generating a second gradient value. This enables the optimiser 116 to apply a gradient-based optimisation algorithm using the first gradient value and the second gradient value to generate the update to the camera pose estimate 118 and the update to the set of parameters of the model 120.

In some examples, the observation of the environment includes multiple frames, e.g. when the image data 106 includes image data captured over time. For each frame, there is a corresponding camera pose estimate. In these cases, the joint optimisation may include jointly optimising the model 104 and the multiple camera pose estimates corresponding to the multiple frames. For example, the loss function 112 may include a plurality of error terms, with e.g. at least one error term per frame. For example, the loss function 112 may include at least one of a photometric error or a geometric error per frame. This can improve accuracy compared to using a single frame.

For example, the observation may include a first frame associated with a first frame camera pose estimate and a second frame associated with a second frame camera pose estimate. In such an example, the rendered image data 110 may be representative of at least one rendered image portion corresponding to the first frame and at least one rendered image portion corresponding to the second frame. In this example, evaluating the loss function 112 generates a first loss associated with the first frame and a second loss associated with the second frame. The optimiser 116 may then, based on the first loss and the second loss, jointly optimise the first frame camera pose estimate, the second frame camera pose estimate and the model 104. This generates an update to the first frame camera pose estimate, an update to the second frame camera pose estimate, and the update to the model 104.

This example may be readily generalised to W frames where W represents a number of frames selected from the image data 106, to be used to jointly optimise the model 104 and W camera pose estimates. The W camera pose estimates are represented by the set {Tᵢ}, each corresponding to one of the W frames. In this case, the joint optimisation may be expressed as follows:

$${min}_{θ , \{ {T}_{i} \}} ( {L}_{g} + {λ}_{p} {L}_{p} ) ,$$

where the photometric error, Lₚ, and the geometric error, L_{g}, may each include contributions from the first loss and the second loss, and θ represents the set of parameters of the model 104.

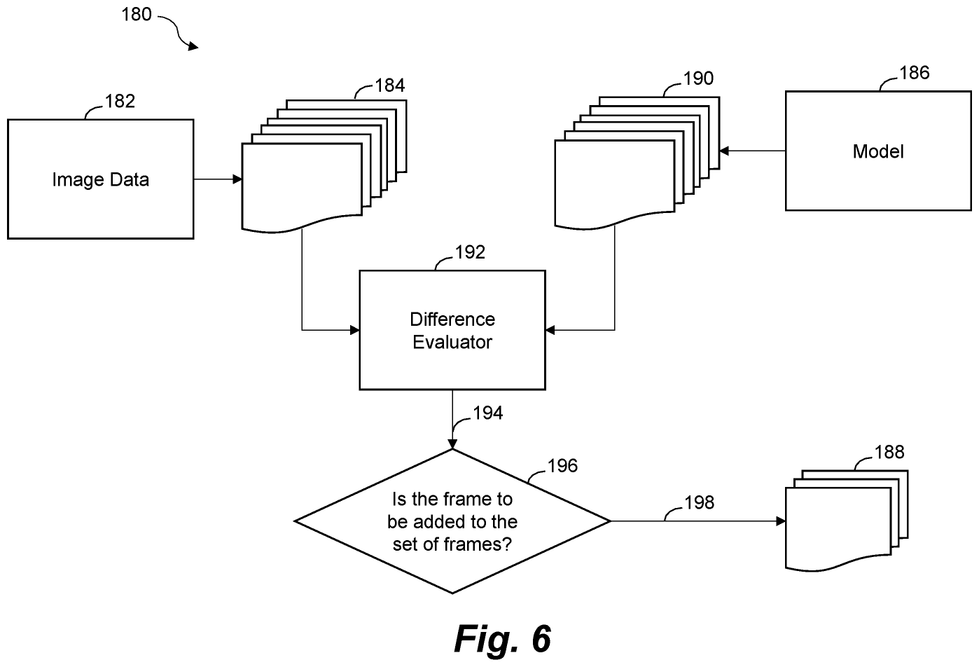

In some examples, an observation of at least part of an environment comprising at least a portion of at least one frame captured by the camera device may be used to select at least one frame from a plurality of frames to be included within the W frames for jointly optimising the model 104. The plurality of frames may have been previously captured by the camera device. In this way, a selection criterion may be adopted to select a frame to be added to the W frames used to jointly optimise the camera pose estimate 102 and the model 104. For example, the at least one frame may be selected based on a difference between at least a portion of a respective frame of the plurality of the frames and at least a corresponding portion of a respective rendered frame. The respective rendered frame may have been rendered based on the W camera pose estimates and the model 104 as described above, e.g. before further joint optimisation of the W camera pose estimates and the model 104 is performed. In some examples, the most recent frame may be selected to be included in the W frames used to jointly optimise the W camera pose estimates and the model 104. In such cases, the most recent frame may be selected irrespective of the difference between the most recent frame and a corresponding rendered frame. Use of the most recent frame for example allows the camera pose estimate(s) and the model 104 to be continually updated as new frames are obtained. Methods for selecting the W frames, which may also be referred to as “keyframes”, are discussed below in more detail with reference to FIG. 6.

FIG. 2 is a schematic diagram showing a method 122 for generating rendered image data, such as the rendered image data 110 of FIG. 1. In this example, the model for generating the 3D representation of the environment is a neural network 124 given by F_{θ} where θ represents a set of parameters of the neural network 124. The neural network 124 may for example be a fully-connected neural network. In the case where the model is a neural network 124, the update to the model generated by the joint optimisation described above is an update to the set of parameters of the neural network 124. A suitable neural network 124 is for example a multilayer perceptron (MLP) with four hidden layers, each with feature size 256 and two output heads. However, this is merely an example and other neural networks may be used in other examples (e.g. MLPs with a different configuration or other types of neural network than an MLP).

An example of a mapping performed by the neural network 124 is shown with respect to a location 126a within the environment with a corresponding 3D spatial coordinate 128 given by p=(x, y; z). The neural network 124 maps the spatial coordinate 128 to a 3D representation 130 of the spatial coordinate 128 which includes a photometric value, c, and a volume density value, ρ, for deriving a depth value as described above. The photometric value, c, may for example comprise a red, green, blue (RGB) vector [R, G, B] indicating red, green, and blue pixel values respectively. The mapping performed by the neural network 124 may therefore be concisely represented as (c, ρ)=F_{θ}(p).

In some examples, prior to inputting the spatial coordinate 128 into the neural network 124, the spatial coordinate 128 may be mapped to a higher dimensional space (e.g. an n-dimensional space) to improve the ability of the neural network 124 to account for high frequency variations in colour and geometry in the environment. For example, a mapping sin(Bp) may be applied to the spatial coordinate 128 prior to input to the neural network 124 to obtain a positional embedding, where B is an [n×3] matrix sampled from a normal distribution, which may be referred to as an embedding matrix. In these examples, the positional embedding may be supplied as an input to the neural network 124. The positional embedding may also be concatenated to a layer of the neural network 124, e.g. to a second activation layer of an MLP. In this way, the embedding matrix B may be considered to be a single fully connected layer of the neural network 124 such that an activation function associated with this single fully connected layer is a sine activation function. In such cases, the set of parameters of the neural network 124 that are updated during the joint optimisation process may include a set of elements of the embedding matrix B.

The method 122 of FIG. 2 is for rendering a pixel 132 of at least one rendered image portion 134 represented by the rendered image data 110. The pixel 132 in this example has a pixel coordinate [u,v]. The method 122 includes applying ray-tracing to identify a set of spatial coordinates 126a-c along a ray 136. The ray 136 is determined based on the camera pose estimate of the camera device 138 and the pixel coordinate of the pixel 132 of the at least one rendered image portion 134 that is to be rendered. For example, the ray 136 may be determined in a world coordinate frame using the equation:

r=T_{WC}K⁻¹[u,v],

where T_{WC} is the camera pose estimate of the camera device 138 and K⁻¹ is an inverse of a camera intrinsics matrix associated with the camera device 138. The camera pose estimate T_{WC} may for example be a transformation with respect to an origin defined in the 3D world coordinate system as discussed above. The camera intrinsics matrix K (e.g. a 3×3 matrix) represents intrinsic properties of the camera device 138 such as the focal length, the principal point offset and the axis skew for example. The camera intrinsics matrix is used to transform 3D world coordinates to 2D image coordinates and so applying the inverse, K⁻¹, maps the pixel coordinate [u,v] to the 3D world coordinates.

The set of spatial coordinates 126a-c in FIG. 2 may not necessarily be three points along the ray 136, but may generally be N points along the ray 136, each with a spatial coordinate pᵢ=dᵢr where each point has a corresponding depth value of a set of depth values {d₁, . . . , d_{N}}. The method 122 includes processing the set of spatial coordinates 126a-c using the model 124, thereby generating a set of photometric values, cᵢ and a set of volume density values, ρᵢ. Each of the set of photometric values and the set of volume density values will be associated with a respective one of the set of spatial coordinates 126a-c.

The method 122 of FIG. 2 then includes a rendering process 140 for generating the rendered image data 110, which in this example is a differentiable rendering process. The rendering process 140 for example includes combining the set of photometric values to generate a pixel photometric value associated with the pixel 132. The rendering process 122 for example also includes combining the set of volume density values to generate a pixel depth value associated with the pixel 132. As the skilled person will appreciate, differentiable rendering allows a 2D representation of a 3D scene to be obtained, for example by using a rendering function which takes various scene parameters as an input and outputs a 2D representation (e.g. comprising photometric values and/or depth values). The parameters input to the rendering function in this case include parameters of the neural network 124, and the camera pose estimate, and may include other parameters such as other camera parameters, lighting parameters and so forth. An example of differentiable rendering is described in “OpenDR: An Approximate Differentiable Rendered”, by Loper et al., published in Computer Vision—ECCV 2014, ECCV 2014, Lecture Notes in Computer Science, vol. 8695, the contents of which are incorporated herein by reference. Differentiable rendering involves computing the gradients of the output representation, e.g. to obtain gradients of a rendered image portion with respect to a camera pose estimate and/or at least one parameter of the neural network 124. The calculated gradients can then be used in a gradient-based optimisation procedure, such as that implemented by the Adam optimiser, discussed above, so as to jointly optimise the camera pose estimate and the at least one parameter of the neural network 124. In this case, the ray 136 described by the equation above is dependent on the camera pose estimate T_{WC} of the camera device 138 allowing the evaluation of a gradient of the ray 136 with respect to the camera pose estimate T_{WC}. The gradient of the ray therefore provides the gradients of the set of spatial coordinates 126a-c along the ray 136 with respect to the camera pose estimate T_{WC}. The gradients of the set of spatial coordinates 126a-c may then be propagated through the remainder of the method 122 of FIG. 2, for example by following the chain rule, to obtain a gradient of a rendered image portion with respect to the camera pose estimate. In one example, the spatial set of coordinates 126a-c are processed using the neural network 124 given by F_{θ}, where θ represents a set of parameters of the neural network 124, to generate the set of photometric values, cᵢ and the set of volume density values, ρᵢ. In this example, gradients of the set of photometric values and the set of volume density values with respect to each of the set of parameters of the neural network 124 may be computed. Applying the chain rule using these gradients, the gradients of the pixel photometric value and the pixel depth value (obtained from the set of photometric values and volume density values as discussed below, for example) with respect to each of the set of parameters of the neural network 124 may be computed.

For example, the set of volume density values may be transformed into a set of occupancy probabilities, oᵢ, representing a probability that an object is occupying each of the set of spatial coordinates 126a-c. The set of occupancy probabilities may be given by:

oᵢ=1−e^{-ρ}^{ᵢ}^{δ}^{ᵢ},

where δᵢ=dᵢ₊₁−dᵢ and represents a distance between neighbouring spatial coordinates (dᵢ₊₁ and dᵢ) in the set of spatial coordinates 126a-c. The set of occupancy probabilities may be used to derive a set of ray termination probabilities, wᵢ, representing a probability that the ray 136 will have terminated (e.g. will be occluded by an object) at each of the set of spatial coordinates 126a-c. The set of ray termination probabilities may be given by:

$${w}_{i} = {o}_{i} {\prod }_{j = 1}^{i - 1} ( 1 - {o}_{j} ) .$$

A ray termination probability in this example is given by the probability that point is occupied given that all points along the ray 136 up to point i−1 are not occupied.

A pixel photometric value Î[u, v] associated with the pixel 132 may be derived by weighting each of the set of photometric values with a respective one of the set of ray termination probabilities such that:

$$\hat{I} [ u , v ] = {\sum }_{i = 1}^{N} {w}_{i} {c}_{i} .$$

Similarly, a pixel depth value \hat{D}[u, v] may be derived by weighting each of the set of depth values with a respective one of the set of ray termination probabilities such that:

$$\hat{D} [ u , v ] = {\sum }_{i = 1}^{N} {w}_{i} {d}_{i .}$$

In some examples, a measure of uncertainty associated with the rendering of the rendered image data 110 is obtained. An example measure of uncertainty is a depth variance along the ray 136 given by:

$${\hat{D}}_{var} [ u , v ] = {\sum }_{i = 1}^{N} {{w}_{i} ( \hat{D} [ u , v ] - {d}_{i} )}^{2} .$$

The depth variance may be used to control a contribution to the geometric error of respective pixels, as described above with reference to method 100 of FIG. 1. For example, the depth variance may be used as a measure of uncertainty, which may then be used to weight a contribution to the geometric error for respective pixels.

In a further example, applying the ray-tracing in the method 122 of FIG. 2 includes applying ray-tracing to identify a second set of spatial coordinates 142a-e along the ray 136. The second set of spatial coordinates 142a-e may not necessarily be five points along the ray 136 but may generally be N₂ points along the ray 136, each with a spatial coordinate along the ray 136. In this example, the second set of spatial coordinates 142a-e are determined based on a probability distribution which is a function of the set of volume density values, ρᵢ, and a distance, δᵢ, between neighbouring spatial coordinates in the first set of spatial coordinates 126a-c. For example, the probability distribution may be based on the set of ray termination probabilities wᵢ defined above such that the second set of spatial coordinates includes more spatial coordinates in regions of greater ray termination probability. In this way, the second set of spatial coordinates 142a-e selected may be in points of the environment containing more visible content rather than points which are either in free space or are in occluded regions of the environment, both of which may have a lesser contribution to the generated pixel photometric and depth values. For example, the spatial coordinate 144 along the ray 136 is in an occluded region behind object 146 and so is not included in the second set of spatial coordinates 142a-e. By selecting the second sets of spatial coordinates 142a-e in points of the environment based on their expected effect on the generated pixel photometric and depth values (e.g. based on the probability distribution), this can increase the rendering efficiency of the rendering process 140.

In this example, the second set of spatial coordinates 142a-e are processed using the model 124, thereby generating a second set of photometric values and a second set of volume density values. The first set of photometric values, associated with the set of spatial coordinates 126a-c, and the second set of photometric values are then combined to generate the pixel photometric value Î[u, v]. In this case, the pixel photometric value Î[u, v] may be generated using the same approach as above but combining the contributions to the pixel photometric value from both the first set of photometric values and the second set of photometric values. This may improve the accuracy of the pixel photometric value Î[u, v].

In this example, the first set of volume density values, associated with the set of spatial coordinates 126a-c, and the second set of volume density values are also combined to generate the pixel depth value D\hat{[}u, v]. In this case, the pixel depth value \hat{D}[u, v] may be generated using the same approach as above but combining the contributions to the pixel depth value from both the first set of volume density values and the second set of volume density values, which may similarly improve the accuracy of the pixel depth value \hat{D}[u, v]. The pixel photometric value Î[u, v] and the pixel depth value \hat{D}[u, v] may be considered to correspond to a 2D representation of at least part of the environment, which 2D representation is generated using the model 104.

Rendering full images for every pixel in each image captured by the camera device and jointly optimising the camera pose estimate and the model of the environment using the full images may be too slow for the methods described above to be applied in real time (although these approaches may nevertheless be useful in situations in which real time modelling of an environment is not needed). For similar reasons, rendering images corresponding to every frame included in the image data (e.g. every frame of a video stream) and jointly optimising the model and each of the camera pose estimates associated with each frame may also be too slow for real time use of the methods described above.

To allow the methods herein to be performed more rapidly and with reduced processing and power consumption, some examples herein involve performing the rendering and joint optimisation described above for a selected number of pixels within an image and/or for a selected number of frames within a video stream. This for example allows the methods herein to be performed in real time, e.g. as a robotic device is navigating an environment, to allow the robotic device to

The methods described herein may therefore include obtaining first and second image data, each captured by the camera device. The first image data may represent an observation of at least a first part of the environment and the second image data may represent an observation of at least a second part of the environment. These observations of parts of the environment may correspond to either respective pixel(s) with an image and/or respective frame(s) within a video stream. In such examples, generating the rendered image data 110 as described above may include generating the rendered image data 110 for the first part of the environment without generating the rendered image data 110 for the second part of the environment. In other words, the rendered image data 110 may be generated for portion(s) of the environment corresponding to a subset of pixels and/or frames of the image data 106, rather than e.g. generating rendered image data 110 for an entire frame of image data 106 and/or for each frame of image data 106 received. In this way, the processing required generating the rendered image data 110 may be reduced and the amount of data used in the joint optimisation process may be reduced.

In some examples, information acquired during a first joint optimisation of at least the camera pose estimate and the model may be used to inform a further joint optimisation of at least the camera pose estimate and the model, e.g. to inform which data is to be used in the further joint optimisation. This for example enables the selection of pixels within an image and/or frames within a video stream that may be of greater benefit when jointly optimising the model and the camera pose estimate(s) than other pixels and/or frames. For example, the selected pixels and/or frames may be associated with a higher loss than other pixels and/or frames, so jointly optimising the model and camera pose estimate(s) using the these pixels and/or frames for example provides a greater improvement to the model and the camera pose estimate(s).

For example, the methods described above may include determining that further rendered image data is to be generated for a second part of the environment, an observation of which is represented by second image data. This further rendered image data may be for jointly optimising at least the camera pose estimate and the model of the environment. In response to such a determination, the further rendered image data may be generated using the methods described above based on the camera pose estimate and the model. Determining that the further rendered image data is to be generated may be performed after the rendered image data 110 has been generated and used to evaluate the loss function and jointly optimise at least the camera pose estimate and the model based on the loss. In this case, the loss may be used to determine that the further rendered image data is to be generated. For example, the further rendered image data may be generated for a part of the environment with a high loss. For example, determining that the further rendered image data is to be generated may include, based on the loss, generating a loss probability distribution for a region of the environment comprising both the first and second parts of the environment. The loss probability distribution may represent how the loss is distributed across the region of the environment, e.g. so as to identify areas of higher loss within the region. Based on the loss probability distribution, determining that the further rendered image data is to be generated may include selecting a set of pixels corresponding to the second image data, for which the further rendered image data is to be generated. In this way, the further rendered image data can for example be generated for areas of higher loss, and then used for jointly optimising at least the camera pose estimate and the model.

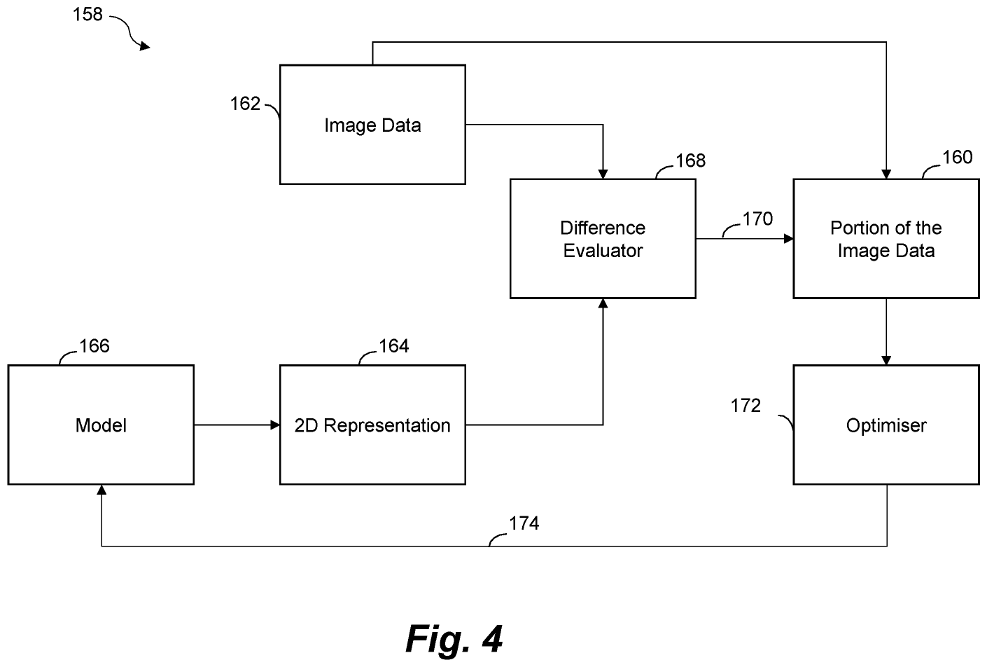

Example methods by which pixels and/or frames are selected for rendering and optimisation are described below in more detail with reference to FIGS. 4 to 8.

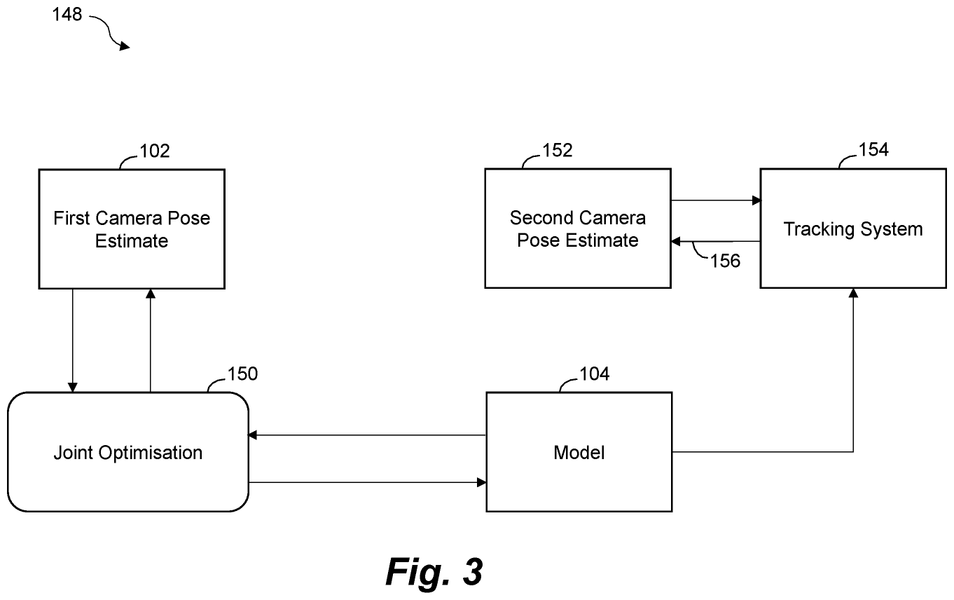

Referring now to FIG. 3, FIG. 3 is a schematic diagram showing a method 148 for tracking a camera pose. The method 148 of FIG. 3 involves performing joint optimisation 150 of the first camera pose estimate 102 and the model 104, for example as explained above with reference to FIGS. 1 and 2.

The method 148 of FIG. 3 includes obtaining a second camera pose estimate 152 associated with a second observation of the environment. The second observation in this case is subsequent to the first observation with which the first camera pose estimate 102 is associated. For example, the first observation may include a first frame of a video stream and the second observation may include a second frame of a video stream subsequent to the first frame. In the method 148 of FIG. 3, a tracking system 154 optimises the second camera pose estimate 152 based on the second observation of the environment and the model 104, thereby generating an update to the second camera pose estimate 156. Since the model 104 has been optimised during the joint optimisation 150, the second camera pose estimate 152 is aligned with a more up-to-date model 104 of the environment to provide an update to the second camera pose estimate 156 that more accurately represents a camera pose associated with the second observation of the environment.

In some examples, the method 148 may include evaluating a loss function based on the second observation of the environment and a rendered image portion corresponding to the second observation. The rendered image portion corresponding to the second observation may be generated using the model 104. Evaluating the loss function in this way may generate a loss associated with the second observation of the environment. The optimisation of the second camera pose estimate 152 may be performed based on the loss associated with the second observation. For example, the optimisation may include iteratively evaluating the loss associated with the second observation for different second camera pose estimates 152, so as to obtain a second camera pose estimate for which a particular value of the loss associated with the second observation is obtained (e.g. a minimum value, or a value that satisfies a particular condition). The loss function evaluated may be the same as the loss function evaluated for jointly optimising at least the camera pose estimate and the model as discussed above with reference to FIG. 1, and a similar optimisation algorithm may be used, e.g. the Adam optimiser algorithm. However, the optimisation may be performed with respect to the second pose estimate 152 but not with respect to the model (as in this case, the parameters of the model are fixed during the optimisation of the second camera pose estimate 152 by the tracking system 154).

As noted above, in examples herein a portion of image data captured by the camera device is selected for optimising a model of the environment. This for example reduces processing power and memory requirements.

FIG. 4 is a schematic diagram showing a method 158 for selecting a portion of image data 160 for optimising a model 162 of the environment. An example of a system applying the method 158 is described in more detail below with reference to FIG. 10.

The method 158 of FIG. 4 includes obtaining image data 162 captured by a camera device. The image data 162 represents an observation of an environment, for example a 3D space as described above. The method 158 of FIG. 4 includes obtaining a 2D representation 164 of at least part of the environment using a model 166 of the environment. The model 166 may be the model 104 described above with reference to FIG. 1, and may be a neural network 124 as described above with reference to FIG. 2 where in such cases, obtaining the 2D representation includes applying a rendering process to an output of the neural network. In this way, the model 166 may be used to generate a 3D representation of the at least part of the environment. The 2D representation 164 of the at least part of the environment may then be obtained using the 3D representation.

In the method 158 of FIG. 4, a difference evaluator 168 evaluates a difference 170 between the 2D representation 164 and at least part of the observation. The at least part of the observation is represented by the image data 162 and is of the at least part of the environment represented by the 2D representation 164. The difference 170 thus provides a measure of accuracy of the 2D representation 164 obtained using the model 166 with respect to the same at least part of the environment captured by the camera device.

In some examples, the difference 170 represents a geometric error. For example, the observation of the environment may include a measured depth observation of the environment captured by the camera device, such as an RGB-D camera. The 2D representation 164 obtained using the model 166 in this case includes a rendered depth representation of the at least part of the environment. In such cases, the geometric error represented by the difference 170 is based on the measured depth observation and the rendered depth representation. In this way, the geometric error associated with the 2D representation 164 may be used to select a portion of the image data 160 for optimising the model 166 of the environment. In other examples, though, the difference 170 may represent a different error, such as a photometric error.

Based on the difference 170, the portion of the image data 160 is selected for optimising the model 166 of the environment. The portion of the image data 160 represents a portion of the observation of the environment. By selecting a portion of the image data 160 for optimising the model 166, e.g. rather than using the entirety of the image data 162, the processing power and memory capacity to optimise the model 166 for each observation of the environment is reduced. This for example allows the model 166 to be optimised more efficiently. In some examples where the observation of the environment includes at least one image, selecting the portion of the image data 160 includes selecting a subset of pixels of the at least one image. In such examples, the at least one image may include a plurality of frames. In such cases, selecting the portion of the image data 160 may include selecting a subset of pixels of one of the frames or of at least two of the plurality of frames.

Basing the selection of the portion of the image data 160 on the difference 170 for example enables portions to be chosen for which there is a greater difference 170. This may for example enable optimisations of the model 166 to be performed using a portion of the image data 160 representing an unexplored, or lesser-explored portion of the observation of the environment captured by the camera device. This for example leads to more rapid convergence of the optimisation than optimising the model 166 based on a portion of the environment that has been previously and frequently explored, which may already be accurately represented by the model 166. For example, a portion of the image data 160 may be selected for which there is a higher difference, indicating that the 2D representation 164 obtained using the model 166 deviates from the corresponding at least part of the observation captured by the camera device to a greater extent. A size of the portion of the image data 160 selected (e.g. corresponding to the size of the region of the environment represented by the portion of the image data 160) may also or additionally be based on the difference 170. The size of the portion of the image data 160 may correspond to a number of pixels selected from within an image and/or a number of frames selected from within a video stream for the optimisation of the model 166.

Evaluating the difference 170 may include generating a first difference by evaluating a difference between a first portion of the observation and a corresponding portion of the 2D representation 164. Evaluating the difference 170 may then include generating a second difference by evaluating a difference between a second portion of the observation and a corresponding portion of the 2D representation 164. In this case, selecting the portion of the image data 160 for example includes selecting a first portion of the image data corresponding to the first portion of the observation and selecting a second portion of the image data corresponding to the second portion of the observation. The first portion of the image data may represent a first number of data points and the second portion of the image data may represent a second number of data points. In an example where the second difference is less than the first difference, the second number of data points is smaller than the first number of data points, so as to use more data points for the optimisation of the model 166 from portions of the image data 162 where the difference 170 is greater. As noted above, one reason why the second difference may be less than the first difference is because the first portion of the observation captured by the camera device may represent a lesser-explored portion of the environment than the second portion. That is, fewer iterations of the optimisation of the model 166 may have been based on the first portion of the image data than the second portion of the image data meaning that the model 166 may generate a less accurate (shown by a larger difference) 2D representation of the first portion than that of the second portion. In other examples, though, the second difference may be greater than the first difference because the second portion of the observation of the environment is less detailed than the first portion of the observation of the environment. For example, the second portion of the observation may include less variation in colour and/or depth, e.g. due to fewer objects or fewer object borders in the second portion of the observation compared to the first portion of the observation. In further examples, the second difference may be less than the first difference due to a failure in stability of the model 166 in which less knowledge of the first portion of the observation of the environment is preserved by the model 166 than that of the second portion of the observation. In cases where the model 166 is a neural network, this may be known as “catastrophic forgetting” in which updates to the model 166 from more recent optimisation iterations may overwrite previous updates to the model 166. It is to be appreciated that, in some cases, the second difference may be greater than the first difference due to a combination of various factors, such as a combination of two or more of these factors.

In the method 158 of FIG. 4, an optimiser 172 optimises the model 166 using the portion of the image data 160. The optimiser can thereby generate an update 174 to the model, such as an update to a set of parameters of the model 166. In an example where the model 166 is a neural network, optimising the model may include optimising a set of parameters of the neural network, thereby generating an update to the set of parameters of the neural network (e.g. as explained with reference to FIG. 2). In some examples, optimising the model 166 may be part of a joint optimisation of the model 166 and a camera pose estimate for the observation of the environment as discussed above with reference to FIGS. 1 and 2. In this case, the method 158 of FIG. 4 may include obtaining a camera pose estimate for the observation of the environment. In such examples, the 2D representation 164 may be generated based on the camera pose estimate and the model 166. The optimiser 172 may then jointly optimise the camera pose estimate and the set of parameters of the neural network based on the difference 170. This may generate both an update to the camera pose estimate and the update to the set of parameters of the neural network. In this way, the joint optimisation in methods described herein may use a selected portion of the image data 160, e.g. selected using the method 158 of FIG. 4.

In some examples, the method 158 of FIG. 4 includes evaluating a loss function based on the 2D representation 164 and the at least part of the observation of the environment, thereby generating a loss for optimising the model 166. Evaluating the loss function may include evaluating the difference 170 such that the loss function comprises the difference 170 between the 2D representation and the at least part of the observation of the environment. In this case, the portion of the image data 160 is selected based on the loss and the optimiser 172 optimises the model 166 based on the loss. In this way, the loss can be used for both purposes, further improving the efficiency of the method 158, and reducing processing and power consumption.

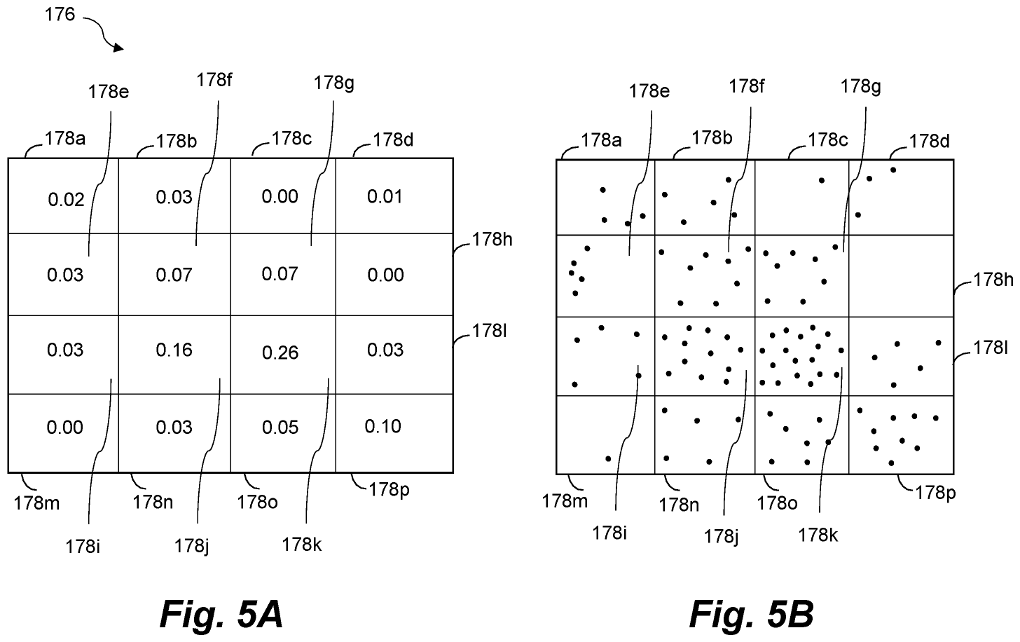

FIGS. 5A and 5B are schematic diagrams showing a method 176 for selecting a portion of image data for optimising a model of the environment, which may be referred to as “image active sampling”. In this case, the observation of the environment includes at least one image as shown by the image 178. In this example, selecting the portion of the image data, as described above with reference to FIG. 4, includes selecting a subset of pixels of the at least one image for optimising the model of the environment. In this example, a distribution of the selected subset of pixels across the at least one image is based on a loss probability distribution generated by evaluating the loss function for at least part of the observation (e.g. for each of a plurality of pixels of the image 178). In the example of FIG. 5A, this is shown by values of the loss for each of the regions 178a-p generated by evaluating an average loss for each of the regions 178a-p (e.g. based on averaging the values of the loss for pixels of the image 178 within each region, which may be a subset of the pixels within each region). In this way, a greater number of pixels may be selected in regions of the image of higher loss. In some examples, the distribution of the subset of pixels across the at least one image may be such that at least one pixel in the subset of pixels is spatially disconnected from each other pixel in the subset of pixels. This is shown in the example of FIG. 5B by the dots in the image 178 representing each pixel in the selected subset of pixels. This enables the selection of the subset of pixels to not be specifically localised in a particular region of the image but instead be distributed across the image to multiple, disconnected regions of the image that may each have a significant loss.

FIGS. 5A and 5B show a way in which the loss probability distribution may be generated and used as a basis for selecting the subset of pixels to be used for optimising the model.

FIGS. 5A and 5B show an image 178 which has been divided into a plurality of regions 178a-p. In the example of FIGS. 5A and 5B, the image 178 is divided into a [4×4] grid but in other examples, the image 178 may be divided into a grid of any size, which need not necessarily have an equal number of rows and columns. For each of the plurality of regions 178a-p, the loss function is evaluated, thereby generating a region loss for the each of the plurality of regions 178a-p. This is shown by the value of the region loss given for each of the plurality of regions 178a-p in FIG. 5A. For example, the loss function may be evaluated for a set of pixels, rⱼ, in each region, Rⱼ, where j={1, 2, . . . , 16} in the example of FIGS. 5A and 5B (where the set of pixels may be all of the pixels in a given region, or a subset of pixels of the region). In some examples, the set of pixels may initially be evenly distributed across the image 178, e.g. so that each of the plurality of regions 178a-p includes the same number and distribution of pixels that form the set of pixels (for which the loss function is evaluated). The distribution of selected pixels may then be adapted iteratively, e.g. based on the region loss.

The loss function may be evaluated using an error, such as the geometric error, in order to calculate an average loss within each region given by:

$$L [ j ] = \frac{1}{\vert {r}_{j} \vert} {\sum }_{( u , v ) ∈ {r}_{j}} \vert D [ u , v ] - \hat{D} [ u , v ] \vert ,$$

where D[u, v] is a pixel depth value of the at least part of the observation captured by the camera device and \hat{D}[u, v] is a corresponding pixel depth value from the 2D representation generated using the model of the environment. It is to be appreciated that a different error, such as a photometric error, may be used instead or in addition in other examples.

In some examples the set of pixels, rⱼ, initially selected (which may e.g. be uniformly distributed) and the region loss for each of the plurality of regions 178a-p may be used to optimise the model of the environment, or jointly optimise the model along with a camera pose estimate associated with the image 178. In this way, evaluating the loss function for each of the plurality of regions 178a-p may be used to optimise the model, and then to select the subset of pixels based on the loss probability distribution, the subset of pixels being used to further optimise the model.

In the example of FIGS. 5A and 5B, the loss probability distribution is then generated based on the loss for the image 178 and the region loss of the each of the plurality of regions 178a-p. In some examples, the loss for the image 178 is provided by a sum of the region losses of the each of the plurality of regions 178a-p. In such an example, the loss for the image may be used to normalise the region loss such that the loss probability distribution is given by:

$$f [ j ] = \frac{L [ j ]}{{\sum }_{m = 1}^{16} L [ m ]} .$$

for the example of FIGS. 5A and 5B, in which there are 16 regions. Therefore, given a total number of pixels, n, in the subset of pixels, the number of pixels selected as part of the subset of pixels from each of the plurality of regions 178a-p is given by nf[j]. In this way, the loss probability distribution can therefore be used to select pixels for optimisation of the model such that more pixels are selected in regions of higher loss. In some examples, the number, nf[j], of pixels selected for each of the plurality of regions 178a-p may be randomly distributed within each of their respective regions, but with the number of pixels selected per region based on the loss probability distribution.

In FIG. 5A, the region loss for each of the plurality of regions 178a-p is shown and in FIG. 5B, the distribution of the subset of pixels across the same image 178 is shown. In this case, more pixels in the subset of pixels is found in the regions such as 178j, 178k and 178p where the region loss is greater than regions such as 178c, 178h and 178m where fewer pixels are found in the subset of pixels selected.

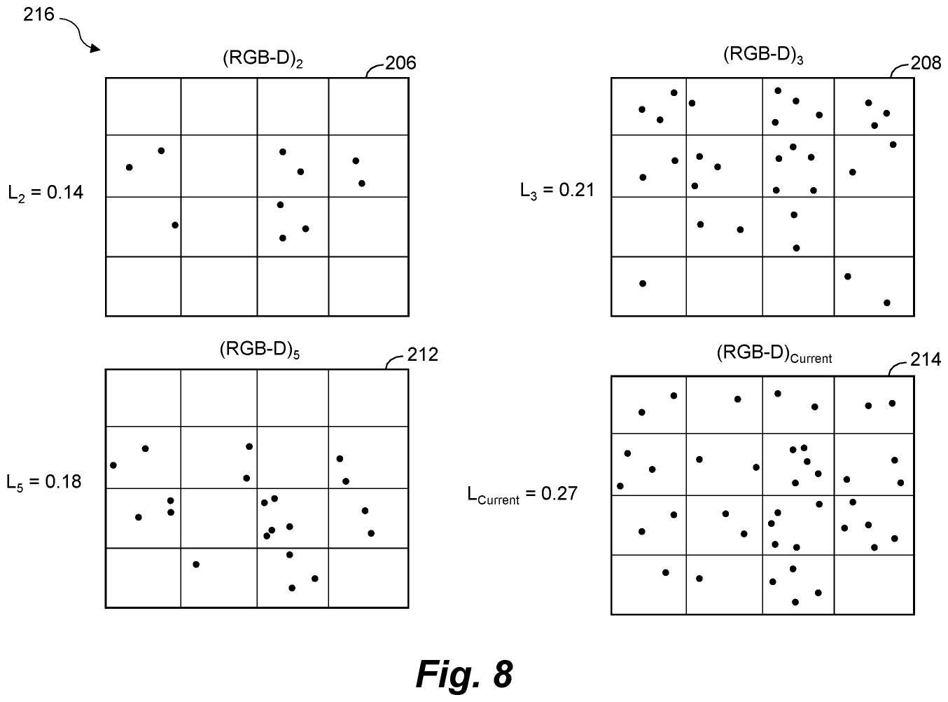

A further example of how the total number, n, of pixels in the subset of pixels selected is derived is described below with reference to FIG. 8.

FIG. 6 is a schematic diagram showing a further example method 180 for selecting a portion of image data for optimising a model 186 of the environment, which may be referred to as “keyframe selection”. The model 186 may for example be any of the models described in other examples herein. In the example of FIG. 8, the image data 182 obtained represents an observation of the environment in which the observation includes a plurality of frames 184. Optimising the model 186 based on each frame in the plurality of frames 184 may not be computationally feasible in terms of the processing power and memory requirements, especially for real-time applications in systems described herein. Therefore, the method 180 of FIG. 6 involves selecting a set of frames 188 for optimising the model 186. The set of frames 188 may be referred to as keyframes which are chosen for use in optimising the model of the environment 186. Frames captured by the camera device may be added to the set of frames 188 as the camera device explores new regions of the environment such that the set of frames 188 more comprehensively spans the environment, which can improve the accuracy of 2D representations obtained using the model 186. Storing a set of frames 188 for optimising the model 186 enables subsequent optimisations of the model 186 to involve the use of the set of frames 188 as opposed to each of the plurality of frames 184, reducing the number of frames used for the optimisation of the model 186. Furthermore, the set of frames 188 provide an archive of frames previously captured by the camera device such that using the set of frames 188 for optimising the model 186 may work to alleviate catastrophic forgetting of the model 186. For example, when the model 186 is a neural network, optimising the neural network solely based on the most recent frame captured by the camera device may allow the neural network to forget the knowledge acquired from previous optimisations based on previous frames, e.g. due to a lack of stability of the neural network. In contrast, by optimising the model using the set of frames 188, knowledge acquired by the neural network from previously captured frames may be re-used to optimise the neural network, thereby reducing the likelihood of catastrophic forgetting of the model 186.

In the method 180 of FIG. 6, a respective frame of the plurality of frames 184 is compared to a 2D representation of the respective frame 190. In this case, the difference evaluator 192 evaluates the difference 194 between the respective frame of the plurality of frames 184 and the 2D representation of the respective frame 190.

In this example, selecting the portion of the image data, as discussed above with reference to FIG. 4, includes selecting, based on the difference 194, a subset of the plurality of frames 184 to be added to the set of frames 188 for optimising the model 186. This is considered for a single frame in the plurality of frames 184 in the method 180 of FIG. 6, in which it is determined 196, based on the difference 194, whether the frame is to be added to the set of frames 188. In response to determining that the frame is to be added to the set of frames 188, the frame is added 198 to the set of frames 188 for optimising the model 186.

To determine whether a frame in the plurality of frames 184 is to be added to the set of frames 188, the method 180 of FIG. 6 may include obtaining a first set of pixels of the frame captured by the camera device. Using the model 186, a second set of pixels of the 2D representation may be generated corresponding to the first set of pixels of the frame captured by the camera device. The difference evaluator 192 may then evaluate the difference 194, which in this case includes the difference between each pixel in the first set of pixels and a corresponding pixel in the second set of pixels. It is to be appreciated that a pixel in this context may refer to a photometric pixel (e.g. representing a photometric value), or a depth pixel (e.g. representing a depth value). The determining step 196 may then include determining a proportion of the first set of pixels for which the difference is lower than a first threshold. This may in some examples represent a proportion of the frame which is already well explained by the 2D representation generated using the model 186. In this case, selecting the frame to be added to the set of frames 188 includes determining that the proportion is lower than a second threshold. By being lower than the second threshold, this for example indicates that an insufficient proportion of the frame is well explained by the 2D representation generated by the model 186 and thus that this frame is to be added to the set of frames 188 for optimising the model 186, so as to improve the model 186 so it more accurately represents the frame. In this way, the frame may be added to the set of frames 188 when the frame is deemed to provide a sufficient amount of new information of the environment to the model 186 compared to the information provided by other frames in the set of frames 188.

For example, the difference 194 may represent a geometric error corresponding to a difference between each depth pixel value D[u,v] in the first set of pixels and a corresponding depth pixel value \hat{D}[u, v] in the second set of pixels. In this case, the proportion described above may be given by the following formulation:

$$P = \frac{1}{\vert s \vert} {\sum }_{( u , v ) ∈ s} ( \frac{\vert D [ u , v ] - \hat{D} [ u , v ] \vert}{D [ u , v ]} < {t}_{d} ) ,$$

where t_{d} represents the first threshold and s represents pixel coordinates of the first set of pixels of the frame for which the difference 194 is evaluated. In some examples, the first set of pixels are uniformly distributed across the frame. This may, when generating the proportion P of the first set of pixels for which the difference 194 is lower than the first threshold t_{d}, give a proportion more representative of the difference 194 across the frame compared to a case where the first set of pixels are distributed to be concentrated in certain areas of the frame compared to other areas. In other examples, though, the difference 194 may represent a different error, such as a photometric error.

As described above, the proportion P may then be assessed to determine whether it is lower than a second threshold, tₚ, and therefore whether the frame is selected to be in the set of frames 188. For a given second threshold, tₚ, frames with a lower proportion P may be more likely to be added to the set of frames 188 because such frames may have a large difference 194. In this way, more frames may be added to the set of frames 188 for areas of the environment where there is a high amount of detail, e.g. in which the camera device is closer to objects in the environment or in which there are numerous object borders, than for areas of low detail, e.g. surfaces of uniform depth in the environment.

The first and second thresholds may be predetermined to enable adjustment of the criteria required for the frame to be added to the set of frames 188. This may have the effect of adjusting the number of frames in the set of frames 188 that are used to optimise the model 186, e.g. based on the processing capability of a system to perform the method 180.

In some cases, the method 180 of FIG. 6 includes selecting a most recent frame captured by the camera device to be added to the set of frames 188. This may be regardless of the difference 194 calculated with respect to the most recent frame. For the most recent frame captured by the camera device, the model has likely not yet been optimised using this frame meaning there will likely be a large difference between the 2D representation of the most recent frame and the most recent frame captured by the camera device. Therefore, it can be desirable to select the most recent frame as one of the set of frames 188 used to optimise the model 186 irrespective of the difference 194 for the most recent. This is because the most recent frame may show a region of the environment that is newly explored or has not been explored recently, which the model 186 may not accurately model or may have started to forget over time, e.g. due to catastrophic forgetting described above.

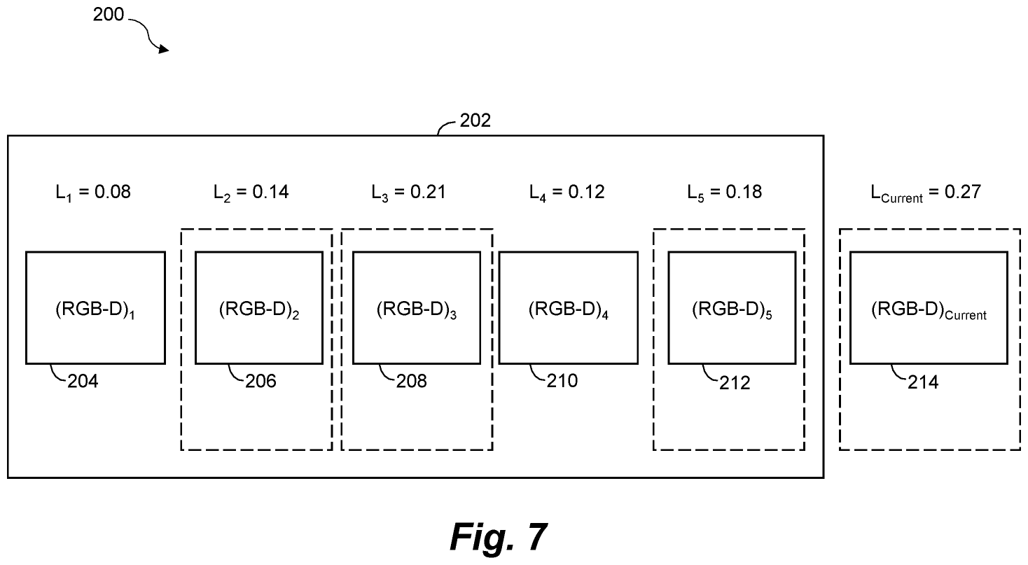

FIG. 7 is a schematic diagram showing a further example method 200 for selecting a portion of image data for optimising a model of the environment, such as any of the models described in the examples herein. FIG. 7 shows a group of frames 202 stored for use in optimising a model of the environment. The group of frames 202 may be referred to as keyframes. As shown in the method 180 of FIG. 6, a number of frames in the group of frames 202, i.e. the number of keyframes, may grow as the camera device explores new regions of the environment and adds new frames to the number of keyframes. This may mean that optimising the model based on a large number of keyframes becomes increasingly computationally expensive. The method 200 of FIG. 7 includes choosing a bounded window of keyframes from the group of frames 202 for optimising the model of the environment. The choice of the bounded window may be based on a distribution of the loss across the group of frames 202 such that the bounded window of keyframes includes frames for which there is a higher loss, as these frames may represent the frames for which the model requires optimising to a greater extent. A bounded window for example is bounded in that it includes a predetermined number of frames. However, the frames need not be consecutive frames captured by the camera device.

In this example. the group of frames 202 comprises five RGB-D frames 204-212. Each of the five RGB-D frames 204-212 may have been selected to be in the group of frames 202 based on the method 180 described above with reference to FIG. 6. There is also shown a most recent frame (RGB-D)_{current} that may be used to optimise the model of the environment. The most recent frame (RGB-D)_{current} may therefore also be considered to be a keyframe included in the group of frames 202.

In the method 200 of FIG. 7, the loss function is evaluated for each of the group of frames 202 based on the respective frame and a 2D representation of the respective frame generated by the model, thereby generating a loss, L₁-L₅ and L_{current}, for each of the group of frames 202. From the loss for each of the group of frames 202, the method 200 of FIG. 7 includes selecting a bounded window of the group of frames 202 for use in optimising the model (where the bounded window for example corresponds to a selected subset of frames 202 for use in optimising the model). The frames chosen to be in the bounded window in this example are shown by the frames with a dashed box around them, that is the frames (RGB-D)₂ 206, (RGB-D)₃ 208, (RGB-D)₅ 212. These frames have been chosen in this example due to having the greatest losses within the group of frames 202. The most recent frame (RGB-D)_{current} 214 captured by the camera device in this case is also chosen to be in the bounded window of keyframes. In this example, the model has not yet been optimised using the most recent frame meaning there is a larger loss between the 2D representation of the most recent frame and the most recent frame compared to the losses associated with other frames. This is shown by the loss evaluated for the most recent frame, L_{current}=0.27, being the highest loss amongst the losses for the frames shown in FIG. 7. In this example, three keyframes are chosen from the group of frames 202 as well as the most recent frame captured by the camera device to be in the bounded window of keyframes. However, in other examples, the number of keyframes in the bounded window may be a different number which may be predetermined according to a desired number of keyframes to use to optimise the model. This may fix the number of frames used to optimise the model according to demands of the system in which the model optimisation is to be incorporated, e.g. there may be a limit to the number of frames useable to optimise a model of the environment in a real-time SLAM system.

FIG. 8 is a schematic diagram showing a method 216 for selecting a portion of image data for optimising a model of the environment. The method 216 of FIG. 8 shows an example of a combination of the method 176 of FIGS. 5A and 5B and of the method 200 of FIG. 7. FIG. 8 shows the number of pixels selected for optimising the model from each of the frames (RGB-D)₂ 206, (RGB-D)₃ 208, (RGB-D)₅ 212 and (RGB-D)_{current} 214 which were selected to be in the bounded window of keyframes in the method 200 of FIG. 7.

Taking the frames (RGB-D)₂ 206 and (RGB-D)₃ 208 for example, the loss function has been evaluated based on the respective frame and a 2D representation of the respective frame, thereby generating a loss associated with each frame. In this example, the loss associated with (RGB-D)₃ 208 (i.e. L₃=0.21) is greater than the loss associated with (RGB-D)₂ 206 (i.e. L₂=0.14). In this case, in response to determining that L₃ is greater than L₂, selecting the portion of the image data based on the loss for optimising the model includes selecting a number of pixels (n₃) from the frame (RGB-D)₃ 208 and a number of pixels (n₂) from the frame (RGB-D)₂ 206. In this case, as shown by the distribution of the selected pixels in frames (RGB-D)₂ 206 and (RGB-D)₃ 208 of FIG. 8, the number of pixels (n₃) from the frame (RGB-D)₃ 208 is greater than the number of pixels (n₂) from the frame (RGB-D)₂ 206. In this way, the number of pixels (nᵢ) selected for optimising the model from each of the frames in the bounded window of keyframes is determined based on the loss evaluated for each of the respective frames. This is further shown in the example of FIG. 8 by the number of pixels (n_{current}) selected from the most recent frame (RGB-D)_{current} 214 being greater than the number of pixels selected from the other frames in the bounded window of keyframes, due to the corresponding loss, L_{current}, being the largest.

The number of pixels (n₃) selected from the frame (RGB-D)₃ 208 may for example be determined by first determining the total loss for the group of frames 202 shown in FIG. 7 that are used for optimising the model. Determining the total loss includes evaluating the loss function based on the group of frames 202 and a corresponding set of 2D representations of the group of frames 202. The number of pixels (n₃) selected from the frame (RGB-D)₃ 208 may then be determined based on contribution of the loss L₃ to the total loss, for example a ratio between the loss L₃ and the total loss. In this way, the number of pixels selected from each of the frames within the bounded window of keyframes is for example proportional to a contribution of the loss associated with the respective frame to the total loss across the group of frames 202. This therefore enables more pixels to be selected from frames with a higher loss as shown in FIG. 8.

Applying this example generally to the i^{th} keyframe in the bounded window of keyframes, the number of pixels (nᵢ) selected for optimising the model from the i^{th} keyframe may be given by:

$${n}_{i} = M ( \frac{1}{{L}_{g}} {\sum }_{( u , v ) ∈ {s}_{i}} \vert {D}_{i} [ u , v ] - {\hat{D}}_{i} [ u , v ] \vert ) ,$$

where M represents a total number of pixels to be selected from the bounded window of keyframes, sᵢ represents pixel coordinates of a set of pixels of the i^{th} keyframe for which the loss function is evaluated, the loss function in this example includes a difference between depth values of the i^{th} keyframe captured by the camera device, Dᵢ[u, v], and depth values of a 2D representation of the i^{th} keyframe \hat{D}ᵢ[u, v]. L_{g} is a total geometric loss across the group of frames 202.

In the method 216 of FIG. 8, each of the frames in the bounded window of keyframes has been divided into a plurality of regions, similarly to the image active sampling method 176 described above with reference to FIGS. 5A and 5B. Following the method 176 of FIGS. 5A and 5B, a loss probability distribution fᵢ[j] across the i^{th} keyframe (where j={1, 2, . . . , 16} in this example as each frame is divided into a [4×4] grid) may be evaluated to determine the number of pixels (nᵢ) to be selected in different respective regions of the i^{th} keyframe. In this way, the number of pixels selected for each region of the i^{th} keyframe may be given by nᵢfᵢ[j]. In some examples, the nᵢfᵢ[j] pixels may be randomly distributed across each of their respective regions.

In this way, the method 216 of FIG. 8 includes a loss-based selection of a bounded window of keyframes within the group of frames 202 for optimising the model of the environment by employing the methods described with reference to FIG. 7. Furthermore, the method 216 of FIG. 8 enables a loss-based selection of the number of pixels from each of those selected keyframes, as well as a distribution of those pixels across each of the keyframes by employing the methods described with reference to FIGS. 5A and 5B.

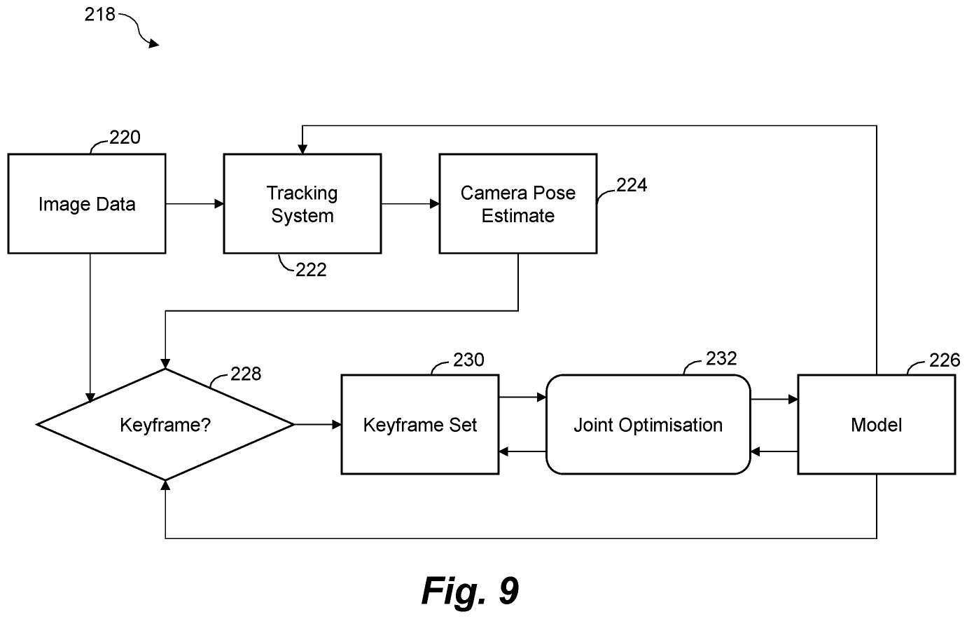

FIG. 9 is a schematic diagram showing a pipeline 218 for a Simultaneous Localisation and Mapping (SLAM) system. In this example, it is shown how the above discussed methods may be combined to be applied in a SLAM system capable of obtaining a 3D dense representation of an environment and/or capable of working in real-time.

In the example pipeline 218 of FIG. 9, image data 220 captured by a camera device is obtained. In this example, the image data includes a frame captured by an RGB-D camera such that for a pixel coordinate (u, v) of the frame, the photometric pixel value is given by I[u, v] which may be an [R, G, B] vector, and the depth pixel value is given by D[u, v].

A tracking system 222 is configured to obtain a camera pose estimate 224 for the image captured by the RGB-D camera using the model 226 (which may be similar to or the same as any of the models described in other examples herein). The model 226 is for generating a 2D representation of the environment corresponding to the frame, and so for a pixel coordinate (u, v), the corresponding photometric pixel value of the 2D representation is given by Î[u, v] and the corresponding depth pixel value of the 2D representation is given by \hat{D}[u, v]. In this example, the tracking system optimises the camera pose estimate 224 based on the frame and the model 226 as explained above with reference to FIG. 3. This may include evaluating a loss function based on the frame and respective 2D representation of the frame generated using the model 226 and optimising the camera pose estimate 224 based on the generated loss.

At step 228 in the pipeline 218, it is determined whether the frame is to be added to a keyframe set 230 used in a joint optimisation process 232 of the model 226 and the camera pose estimates of the keyframe set 230. This may follow the method 180 described above with reference to FIG. 6. The determining step 228 may be performed for each frame captured by the camera device so as to select the frames from the image data 220 for the joint optimisation of the model 226 and the camera pose estimates of the keyframe set 230.

Each keyframe in the keyframe set 230 may include a photometric and depth measurement from the image data 220 and a camera pose estimate from the tracking system 222 such that the i^{th} keyframe may be represented by the set of parameters {Iᵢ, Dᵢ, Tᵢ}, where Tᵢ represents the camera pose estimate.

Prior to the joint optimisation 232 of the model 226 and the camera pose estimates of the keyframe set 230, a bounded window of keyframes may be selected from the keyframe set 230 for the joint optimisation 232. This may follow the loss-based approach described in the method 200 of FIG. 7. The number of keyframes selected to be in the bounded window of keyframes may be given by W. Furthermore, a number of pixels from each keyframe is selected for use in the joint optimisation process 232 as well as a distribution of the number of pixels selected across each keyframe. This may follow the method 216 set out in FIG. 8.

The joint optimisation 232 may then be performed based on the selected pixels of the selected keyframes to generate an update to the model 226 and to the camera pose estimates of each of the selected keyframes used in the joint optimisation 232. The joint optimisation 232 may follow the method 100 described above with reference to FIG. 1. In this case, the loss function is evaluated for the W keyframes and for a selected set of pixel coordinates, (u, v)∈sᵢ from each keyframe (e.g. without evaluating the loss function for other keyframes and other pixels within the selected W keyframes). Therefore, for a total number of pixels, M, to be selected from the bounded window of keyframes, the total photometric loss used in the joint optimisation 232, described above with reference to FIG. 1, may be given by:

$${L}_{p} = \frac{1}{M} {\sum }_{i = 1}^{W} {\sum }_{( u , v ) ∈ {s}_{i}} \vert {I}_{i} [ u , v ] - {\hat{I}}_{i} [ u , v ] \vert .$$

Furthermore, the total geometric loss used in the joint optimisation 232 may be given by:

$${L}_{g} = \frac{1}{M} {\sum }_{i = 1}^{W} {\sum }_{( u , v ) ∈ {s}_{i}} \frac{\vert {D}_{i} [ u , v ] - {\hat{D}}_{i} [ u , v ] \vert}{\sqrt{{\hat{D}}_{var} [ u , v ]}} ,$$

where the depth variance may be used to reduce a contribution to the geometric error of in uncertain areas of a frame such as object borders, as described above with reference to method 100 of FIG. 1.

In this pipeline 218 of the SLAM system, the tracking system 222 operates together with the joint optimisation 232 to provide for SLAM. The tracking system 222 repeatedly optimises a camera pose estimate for the latest frame captured by the camera device with respect to a fixed model 226 that has been updated from the latest joint optimisation 232 iteration (or for a subset of the latest frames captured by the camera device, e.g. those selected for optimisation or for every nth frame). A joint optimisation of the model 226 and the camera pose estimates of selected keyframes can then be performed, e.g. after or at least partly in parallel with the joint optimisation of the camera pose estimate and the model. In this way, the SLAM system builds and updates a model 226 of the environment whilst tracking the pose of the camera device. In some examples, the tracking system 222 performs the tracking process described above at a higher frequency than that at which the joint optimisation process 232 is performed in order to robustly track relatively small displacements of the camera device.

In an example in which the image data 220 is video data, a first frame of a video stream within the video data captured by the camera device may be unconditionally selected to be in the keyframe set 228 (i.e. regardless of a result of the determining step 226). This first frame may be used to initialise the model 226 of the environment. For example, the first frame may be used to define an origin of the 3D world coordinate system for the environment such that camera pose estimates of later frames are defined with respect to this origin. In this way, the model 226 of the environment may be centred around where the camera device begins when exploring the environment. A first joint optimisation iteration may then be performed using the first frame to generate at least an update to the camera pose estimate of the first frame and an update to the model 226. Then as subsequent frames within the image data 220 are obtained, the keyframe set 230 based on which the joint optimisation 232 is performed may expand, so as to repeatedly updating the model 226. In this way, the SLAM system may for example operate in real-time without the model 226 requiring a training phase based on any training data, as the initialisation of the model 226 can for example be performed using the first frame of the video stream.

FIG. 10 is a schematic diagram showing a system 234 configured to perform any of the methods described herein. The system 234 for example may be used for example within a SLAM system. Components as described herein with reference to FIG. 10 may comprise dedicated processing electronics and/or may be implemented by way of computer program code executed by a processor of at least one computing device. In certain cases, one or more embedded computing devices may be used.

The system 234 receives image data described in the methods above, the image data being captured by a camera device. The image data is received via an image data interface 236. The image data interface 236 may be communicatively coupled to the camera devices described in previous examples. The image data interface 236 may include a hardware interface, such as a USB or network interface, and computer program code implementing software drivers, or may be or include a software interface. In one case, the system 234 may be configured to operate on streaming data, e.g. live video data, and may hence include a suitable image data interface 236 for receiving data streamed to the system 234, e.g. via a suitable communication protocol. In another case, the system 234 may be communicatively coupled to the camera device via the image data interface 236 and be arranged to store image data received from the camera device in one or more of persistent or non-persistent data storage. For example, frames of data may be stored in memory and/or a hard disk drive or solid state storage of the system 234.

The system 234 includes a rendering engine 238 to generate rendered image data based on an obtained camera pose estimate for an observation of the environment represented by the image data and a model of the environment according to the examples described above. The rendering engine 238 may be configured to evaluate a loss function based on the image data and the rendered image data. The rendering engine 238 may be a differentiable rendering engine in the sense that the rendering process performed may be differentiable with respect to both camera pose estimate and a set of parameters of the model of the environment as explained in the methods above.

The rendering engine 238 may include an image data portion selection engine 240 for selecting a portion of the image data for optimising the model in accordance with the examples described above. The image data portion selection engine 240 may evaluate a difference between a 2D representation of at least part of the environment obtained using the model and a corresponding at least part of the environment as described in the above examples.

The system 234 also includes an optimiser 242 configured to optimise the model of the environment according to the examples described above. This optimisation may be part of a joint optimisation of at least the camera pose estimate of the observation of the environment and the model of the environment. In this case, the optimiser 242 may be configured to perform the joint optimisation methods as described above to generate an update to the camera pose estimate and an update to the model.

In the example of FIG. 10, the system 234 includes a tracking system 244 configured to track a pose of the camera device, thereby tracking the poses of the camera device during observation of the scene. The tracking system 244 may be configured to optimise a second camera pose estimate of a subsequent observation of the environment using the model updated by the joint optimisation process according to the above examples.

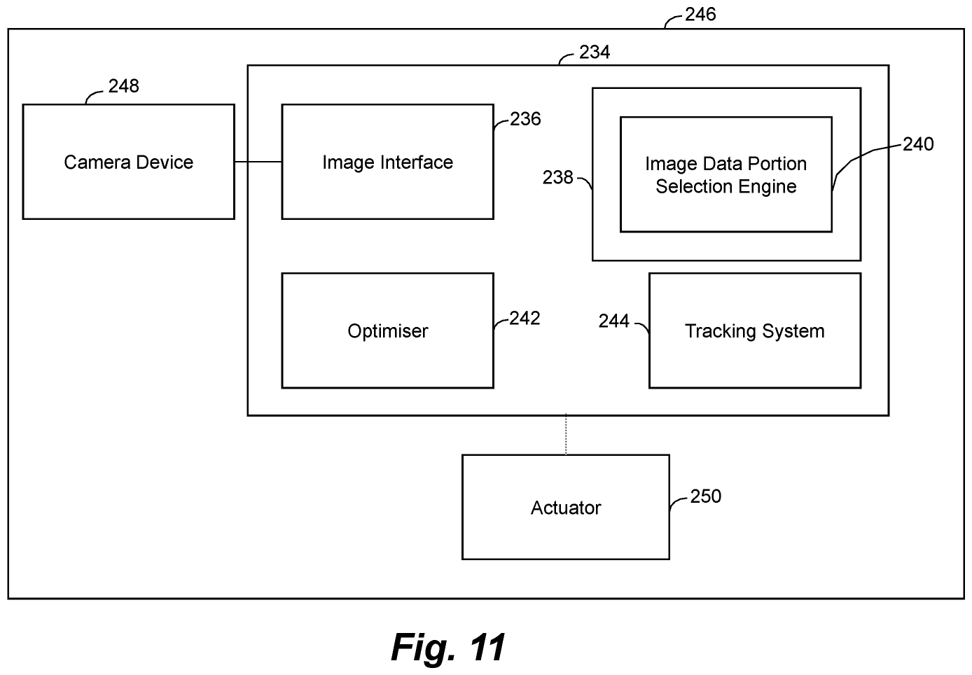

FIG. 11 is a schematic diagram showing a robotic device 246 according to an example.

The robotic device 246 includes a camera device 248 for capturing image data. The camera device 248 may be an RGB-D camera as described in the examples above. The camera device 248 may be mechanically coupled to the robotic device 246. For example, the camera device 248 may be statically mounted with respect to the robotic device 246, or moveable with respect to the robotic device 246.

The robotic device 246 includes the system 234 configured to perform any of the above methods as described above with reference to FIG. 10. The system 234 receives image data form the camera device 248 via the image data interface 236 as described above.

The robotic device 246 also includes one or more actuators 250 to enable the robotic device 246 to navigate around the environment (e.g. a 3D space). The one or more actuators 250 may include tracks, burrowing mechanisms, rotors, etc., so that the robotic device can move around the environment.

The one or more actuators 250 may be communicatively coupled to the system 234 such that results of the methods performed by the system 234 may be used to control the motion of the one or more actuators 250. For example, the one or more actuators 250 may update a direction of navigation of the robotic device 246 around the environment in response to obtaining a representation of an environment using an optimised version of the model obtained by the optimiser 242, where the model may be optimise jointly with at least a camera pose estimate, as described in various examples herein. In this way, updates generated for the model may be used to generate an updated representation of the environment (e.g. a dense representation), which in turn may be used to control the direction of navigation of the robotic device 246 around the environment.

The above examples are to be understood as illustrative examples. Further examples are envisaged. For example, in further examples a non-transitory medium comprising computer-executable instructions. The computer-executable instructions, when executed by a processor of a computer device, cause the computing device to perform any of the methods described herein (alone or in combination with each other).

It is to be understood that any feature described in relation to any one example may be used alone, or in combination with other features described, and may also be used in combination with one or more features of any other of the examples, or any combination of any other of the examples. Furthermore, equivalents and modifications not described above may also be employed within the scope of the accompanying claims.

1. A method, comprising:
obtaining image data captured by a camera device, the image data representing an observation of an environment;
obtaining a two-dimensional representation of at least part of the environment using a model of the environment;
evaluating a difference between the two-dimensional representation and at least part of the observation, wherein the at least part of the observation is of the at least part of the environment represented by the two-dimensional representation;
based on the difference, selecting a portion of the image data for optimising the model, wherein the portion of the image data represents a portion of the observation of the environment; and
optimising the model using the portion of the image data.

2. The method of claim 1, comprising:
using the model of the environment to generate a three-dimensional representation of the at least part of the environment; and
obtaining the two-dimensional representation of the at least part of the environment using the three-dimensional representation.

3. The method of claim 1, wherein the observation comprises at least one image, and selecting the portion of the image data comprises selecting a subset of pixels of the at least one image.

4. The method of claim 3, wherein the at least one image comprises a plurality of frames, and selecting the portion of the image data comprises selecting a subset of pixels of at least two of the plurality of frames.

5. The method of claim 1, wherein evaluating the difference comprises:
evaluating the difference between a first portion of the observation and a corresponding portion of the two-dimensional representation, thereby generating a first difference; and
evaluating the difference between a second portion of the observation and a corresponding portion of the two-dimensional representation, thereby generating a second difference less than the first difference, and
selecting the portion of the image data comprises:
selecting a first portion of the image data corresponding to the first portion of the observation, the first portion of the image data representing a first number of data points; and
selecting a second portion of the image data corresponding to the second portion of the observation, the second portion of the image data representing a second number of data points, smaller than the first number of data points.

6. The method of claim 1, comprising:
evaluating a loss function based on the two-dimensional representation and the at least part of the observation of the environment, thereby generating a loss for optimising the model, wherein evaluating the loss function comprises evaluating the difference between the two-dimensional representation and the at least part of the observation; and
selecting the portion of the image data based on the loss.

7. The method of claim 6, wherein the observation comprises at least one image and selecting the portion of the image data comprises selecting a subset of pixels of the at least one image with a distribution of the subset of pixels across the at least one image based on a loss probability distribution generated by evaluating the loss function for the at least part of the observation.

8. The method of claim 7, wherein generating the loss probability distribution comprises:
dividing the at least part of the observation into a plurality of regions;
evaluating the loss function for each of the plurality of regions, thereby generating a region loss for the each of the plurality of regions; and
generating the loss probability distribution based on the loss and the region loss of the each of the plurality of regions.

9. The method of claim 6, wherein:
the observation comprises a first frame and a second frame;
evaluating the loss function comprises:
evaluating the loss function based on the first frame and a two-dimensional representation of the first frame, thereby generating a first loss;
evaluating the loss function based on the second frame and a two-dimensional representation of the second frame, thereby generating a second loss; and
selecting the portion of the image data based on the loss comprises, in response to determining that the first loss is greater than the second loss:
selecting a first number of pixels from the first frame; and
selecting a second number of pixels from the second frame, and wherein the first number of pixels is greater than the second number of pixels.

10. The method of claim 9, comprising:
determining a total loss for a group of frames for optimising the model, the group of frames comprising the first frame and the second frame, the determining the total loss comprising evaluating the loss function based on the group of frames and a corresponding set of two-dimensional representations of the group of frames; and
determining the first number of pixels based on a contribution of the first loss to the total loss.

11. The method of claim 1, wherein the observation comprises a plurality of frames, the evaluating the difference comprises evaluating the difference between a respective frame of the plurality of frames and a two-dimensional representation of the respective frame, and selecting the portion of the image data comprises selecting, based on the difference, a subset of the plurality of frames to be added to a set of frames for optimising the model.

12. The method of claim 11, wherein the plurality of frames comprises a frame, and the method comprises:
obtaining a first set of pixels of the frame;
generating a second set of pixels of the two-dimensional representation of the frame, wherein evaluating the difference comprises evaluating the difference between each pixel in the first set of pixels and a corresponding pixel in the second set of pixels; and
determining a proportion of the first set of pixels for which the difference is lower than a first threshold, wherein the subset of the plurality of frames comprises the frame, and selecting the frame comprises selecting the frame in response to determining that the proportion is lower than a second threshold.

13. The method of claim 11, comprising selecting a most recent frame captured by the camera device to be added to the set of frames.

14. The method of claim 1, wherein:
the observation of the environment comprises a measured depth observation of the environment captured by the camera device;
the two-dimensional representation comprises a rendered depth representation of the at least part of the environment; and
the difference represents a geometric error based on the measured depth observation and the rendered depth representation.

15. The method of claim 1, wherein:
the model of the environment comprises a neural network and obtaining the two-dimensional representation comprises applying a rendering process to an output of the neural network; and
optimising the model comprises optimising a set of parameters of the neural network, thereby generating an update to the set of parameters of the neural network.

16. The method of claim 15, comprising:
obtaining a camera pose estimate for the observation of the environment, wherein the two-dimensional representation is generated based on the camera pose estimate; and
jointly optimising the camera pose estimate and the set of parameters of the neural network based on the difference; thereby generating:
an update to the camera pose estimate for the observation of the environment; and
the update to the set of parameters of the neural network.

17. A non-transitory computer-readable storage medium comprising computer-executable instructions which, when executed by a processor, cause a computing device to perform operations comprising:
obtaining image data captured by a camera device, the image data representing an observation of an environment;
obtaining a two-dimensional representation of at least part of the environment using a model of the environment;
evaluating a difference between the two-dimensional representation and at least part of the observation, wherein the at least part of the observation is of the at least part of the environment represented by the two-dimensional representation;
based on the difference, selecting a portion of the image data for optimising the model, wherein the portion of the image data represents a portion of the observation of the environment; and
optimising the model using the portion of the image data.

18. A system, comprising:
an image data interface to receive image data captured by a camera device, the image data representing an observation of an environment;
an image data portion selection engine configured to:
obtain a two-dimensional representation of at least part of the environment using a model of the environment;
evaluate a difference between the two-dimensional representation and at least part of the observation, wherein the at least part of the observation is of the at least part of the environment represented by the two-dimensional representation; and
based on the difference, select a portion of the image data for optimising the model, wherein the portion of the image data represents a portion of the observation of the environment; and
an optimiser configured to optimise the model using the portion of the image data.

19. The system of claim 18, being a robotic device, further comprising:
a camera device configured to obtain image data representing an observation of an environment; and
one or more actuators to enable the robotic device to navigate around the environment.

20. The system of claim 19, configured to control the one or more actuators to control navigation of the robotic device around the environment based on the model.
